(19) United States
(12) Patent Application Publication
(10) Pub. No.: US 2026/0227210 A1
(43) Pub. Date: Aug. 6, 2026

(54) CONFIGURABLE USER INTERFACE FOR A LEAK TESTER

(71) Applicant: Uson L.P., Houston, TX (US)

(72) Inventors: Ian Joel Haber, Cypress, TX (US); Royce Allen Simpson, Kokomo, IN (US); Olivia Nellie Pacheco, Houston, TX (US)

(21) Appl. No.: 19/468,820

(22) Filed: Feb. 3, 2026

Related U.S. Application Data
(60) Provisional application No. 63/753,301, filed on Feb. 3, 2025.

(51) Int. Cl. G01D 7/00; G01M 3/00

(52) U.S. Cl. CPC G01D 7/00; G01M 3/00; G01D 2207/30

(57) ABSTRACT

Leak testing systems, methods, and non-transitory computer readable media are disclosed that in some examples include channel boxes comprising a test channel controller (TCC) and pneumatic components. The TCCs are configured to perform different test procedures using the pneumatic components. An enclosure is coupled to a display device and houses memory comprising instructions and a main control unit (MCU). The enclosure receives the channel boxes and pneumatically couples the channel boxes to the enclosure. The MCU is coupled to the memory, communicably coupled to the TCCs when the channel boxes are received, and executes the instructions to obtain from the TCCs test data for the different test procedures, generate a user interface graphically representing the test data and comprising channel sections corresponding to a respective channel comprising one of the channel boxes and one of the TCCs, and output the user interface to the display device for display.

### CROSS-REFERENCE TO RELATED APPLICATIONS

This application claims the benefit of priority of U.S. Provisional Patent Application Ser. No. 63/753,301, filed on Feb. 3, 2025, entitled “Configurable User Interface for a Leak Tester,” the entire contents of which is hereby incorporated by reference herein.

### FIELD

This technology generally relates to systems and methods for air leak testing and, more particularly, to configurable, modular user interfaces for leak testing systems with multi-channel architectures.

### BACKGROUND

Leak testing systems perform a fundamentally straightforward task—detecting leaks in systems or components. However, the process of configuring, automating, and troubleshooting current leak testing system for specific applications is inherently complex and varies significantly from one use case to another. Each application demands distinct configurations, and users require different levels of information access, functionality, and granularity to perform their roles effectively.

Traditional leak testing systems often impose rigid and cumbersome navigation structures, requiring users to sift through complex menus and options to access the information or functionality they need for their immediate task. This design results in inefficiencies, as it either demands a high degree of expertise from on-site personnel or necessitates unrestricted system access for all users. The latter approach increases the likelihood of errors arising from unintended configuration changes or unauthorized access to critical system settings.

### SUMMARY

In some examples, the disclosed technology provides configurable, modular user interfaces for multi-channel leak testing systems, allowing for dynamic adaptation based on user role, testing channel configuration, and real-time system conditions. Exemplary leak testing systems include a display with distinct interface sections or panels corresponding to individual test channels, where each section comprises resizable and reconfigurable functional elements. The interface dynamically adjusts the displayed elements based on the logged-in user's role—such as operator, supervisor, administrator, or service technician—ensuring that each user has access to role-appropriate controls and data while restricting access to non-relevant or unauthorized functions.

The systems and methods described and illustrated herein support independent and sequenced test operations, allowing each channel to operate asynchronously with individual initiated and terminated tests or in a coordinated manner under predefined sequence rules. In response to changes in leak testing system state, user selection, or test progression, the interface advantageously updates in real-time to reflect ongoing operations, prioritize relevant information, and provide interactive functionality for test execution and analysis.

In some examples, a leak testing system is disclosed that includes a plurality of channel boxes each comprising a test channel controller (TCC) and a plurality of pneumatic components. Each of the TCCs is configured to perform a different test procedure using the pneumatic components. In some examples, an enclosure is coupled to a display device and houses memory having instructions stored thereon and a main control unit (MCU). The enclosure is configured to separately receive each of the channel boxes and thereby pneumatically couple the channel boxes to the enclosure. The MCU is coupled to the memory, communicably coupled to the TCCs when the channel boxes are received by the enclosure, and configured to execute the stored instructions to obtain from each of the TCCs test data for the different test procedures. The MCC is further configured to execute the stored instructions to generate a user interface graphically representing the test data and comprising a plurality of channel sections each corresponding to a respective channel comprising one of the channel boxes and an associated with one of the TCCs and output the user interface to the display device for display.

In these examples, each of the channel boxes is separately removable from the enclosure via detachment of a receiving manifold of the channel box from a distribution manifold of the enclosure. Each of the TCCs can include a TCC printed circuit board (PCB) comprising a first set of one or more processors. The MCU can include a second set of one or more processors. Additionally, the enclosure can include a backplane printed circuit board (PCB) configured to connect the MCU to the TCC PCBs via a backplane interface connector of the TCC PCBs.

The enclosure can include a set of test ports for each of the channel boxes. Each of the TCCs can be assigned a different sensor range or is programmed to perform a different test type or model type. The pneumatic components can include at least one main regulator, at least one auxiliary manual regulator, and an internal vacuum generation circuit.

The MCU in some examples is configured to execute the stored instructions to generate the user interface to include or exclude functionality based on stored access privileges for a user of the leak testing system after determining a role of the user after receiving a login request from the user. The role can include a system administrator, a supervisor, an operator, an information technology administrator, or a service technician

The user interface can include an indication of a test pass or fail status and a start/abort button configured to control initiation and termination of one or more of the different test procedures via communication with one or more of the TCCs. The user interface can also include a multi-functional gauge comprising real-time sensor readings obtained from one or more of the TCCs and one or more of the pneumatic components, wherein the sensor readings comprise pressure, flow, or leak rate. In these examples, the user interface can also include an indication of a state of one or more external digital input and output signals and a holding register display comprising real-time numerical data used in one or more of the different test procedures.

The MCU can further be configured to execute the stored instructions to continuously communicate with the TCCs to obtain updated test data and update the output user interface in real-time based on the updated test data. The user interface can include a sequence section representing a progress of each of the different test procedures, wherein one or more of the different test procedures are executed concurrently by one or more of the TCCs. Additionally, each of the channel sections can include a progress bar indicating a completion status of a corresponding one of the different test procedures based on additional test data obtained from each of the TCCs.

One or more of the channel boxes can include different pressure or sensor ranges, a different number of ports, or a different number of regulators. One or more of the channel boxes can include also can include one or more sensors, one or more test ports, one or more pressure regulators, valving, or a TCC-to-backplane interface connector. Each of the channel sections can include a respective portion of the test data associated with a corresponding one of the channels.

In other examples, a non-transitory computer readable medium is disclosed that has stored thereon instructions comprising executable code that, when executed by one or more processors of a leak testing system, causes the one or more processors to perform steps. The steps can include obtaining test data from a plurality of test channel controllers (TCCs). Each of the TCCs is associated with one of a plurality of channel boxes, each of the channel boxes further comprises a plurality of pneumatic components, and each of the TCCs is configured to perform a different test procedure using the pneumatic components. The steps also can include generating a user interface graphically representing the test data and comprising a plurality of channel sections each corresponding to a respective channel comprising one of the channel boxes and an associated with one of the TCCs. Additionally, the steps can include outputting the user interface to a display device of the leak testing system for display, wherein each of the channel sections comprises a respective portion of the test data associated with a corresponding one of the channels.

In these examples, the one or more processors are configured to execute the stored instructions to generate the user interface to include or exclude functionality based on stored access privileges for a user of the leak testing system after determining a role of the user after receiving a login request from the user. The user interface can include an indication of a test pass or fail status and a start/abort button configured to control initiation and termination of one or more of the different test procedures via communication with one or more of the TCCs. Additionally, each of the channel sections can include a progress bar indicating a completion status of a corresponding one of the different test procedures based on additional test data obtained from each of the TCCs.

In yet another example, a method implemented by a leak testing system is disclosed. In these examples, the method includes obtaining test data from a plurality of test channel controllers (TCCs). Each of the TCCs is associated with one of a plurality of channel boxes, each of the channel boxes further comprises a plurality of pneumatic components, and each of the TCCs is configured to perform a different test procedure using the pneumatic components. The method also includes generating a user interface graphically representing the test data and comprising a plurality of channel sections each corresponding to a respective channel comprising one of the channel boxes and an associated with one of the TCCs. Additionally, the method in these examples includes outputting the user interface to a display device of the leak testing system for display, wherein each of the channel sections comprises a respective portion of the test data associated with a corresponding one of the channels.

### BRIEF DESCRIPTION OF THE FIGURES

The accompanying drawings, which are incorporated in and form a part of the specification, illustrate exemplary embodiments and together with the written description serve to explain the principles, characteristics, and features of the technology. In the drawings:

FIG. 1 is a block diagram of exemplary leak testing system components, in accordance with at least one aspect of the present disclosure;

FIGS. 2A-D illustrate open and closed configurations of an exemplary leak testing system, in accordance with at least one aspect of the present disclosure;

FIG. 3 illustrates an exemplary leak testing system architecture, in accordance with at least one aspect of the present disclosure;

FIG. 4 is a front view of an exemplary leak testing system in an open configuration, in accordance with at least one aspect of the present disclosure;

FIGS. 5A-B illustrate an exemplary leak testing system benchtop configuration and wall-mounted configurations, in accordance with at least one aspect of the present disclosure;

FIG. 6 is a rear view of an exemplary leak testing system, in accordance with at least one aspect of the present disclosure;

FIG. 7 illustrates an exemplary leak testing system screen latch override, in accordance with at least one aspect of the present disclosure;

FIG. 8A-C illustrates an exemplary sequence of operations required to dock, undock, and remove a leak testing system channel box, in accordance with at least one aspect of the present disclosure;

FIGS. 9A-C illustrates exemplary leak testing system user interfaces, in accordance with at least one aspect of the present disclosure;

FIG. 10 illustrates an exemplary leak testing system enclosure, in accordance with at least one aspect of the present disclosure;

FIG. 11 illustrates an exemplary the leak testing system access mechanism, in accordance with at least one aspect of the present disclosure;

FIG. 12 illustrates an exemplary leak testing system with a channel box removed, in accordance with at least one aspect of the present disclosure;

FIGS. 13A-B illustrate an exemplary leak testing system channel box extracted from a leak testing system enclosure, in accordance with at least one aspect of the present disclosure;

FIG. 14 is an exemplary leak testing system backplane printed circuit board, in accordance with at least one aspect of the present disclosure;

FIG. 15 illustrates an exemplary leak testing system engagement mechanism between a distribution manifold and a receiving manifold, in accordance with at least one aspect of the present disclosure;

FIG. 16 illustrates an exemplary leak testing system receiving manifold engagement mechanism, in accordance with at least one aspect of the present disclosure;

FIG. 17 illustrates exemplary external device types supported by an exemplary leak testing system, in accordance with at least one aspect of the present disclosure;

FIG. 18 illustrates an exemplary leak testing system operation in asynchronous mode, in accordance with at least one aspect of the present disclosure;

FIG. 19 illustrates an exemplary leak testing system operation in sequenced mode, in accordance with at least one aspect of the present disclosure;

FIGS. 20A-G illustrate exemplary adaptive and modular the user interfaces, in accordance with at least one aspect of the present disclosure;

FIGS. 21A-E illustrate exemplary customizable modular sequence mode user interfaces, in accordance with at least one aspect of the present disclosure;

FIG. 22 illustrates an exemplary advanced program setup user interface, in accordance with at least one aspect of the present disclosure;

FIG. 23 illustrates an exemplary guided setup user interface, in accordance with at least one aspect of the present disclosure;

FIG. 24 illustrates an exemplary test type selection user interface, in accordance with at least one aspect of the present disclosure;

FIG. 25 illustrates an exemplary quick setup user interface, in accordance with at least one aspect of the present disclosure;

FIG. 26 illustrates an exemplary coupling configuration user interface, in accordance with at least one aspect of the present disclosure;

FIG. 27 illustrates an exemplary regulators configuration user interface, in accordance with at least one aspect of the present disclosure;

FIG. 28 illustrates an exemplary adjust user interface, in accordance with at least one aspect of the present disclosure;

FIGS. 29A-B illustrate exemplary run test user interfaces, in accordance with at least one aspect of the present disclosure;

FIG. 30 illustrates an exemplary compensation/calibration user interface, in accordance with at least one aspect of the present disclosure; and

FIG. 31 illustrates an exemplary challenge test user interface, in accordance with at least one aspect of the present disclosure.

### DETAILED DESCRIPTION

This disclosure is not limited to the particular systems, devices, and methods described, as these may vary. The terminology used in the description is for the purpose of describing exemplary versions or embodiments only and is not intended to limit the scope.

The terms “algorithm,” “system,” “module,” “engine,” or “architecture,” if used herein, are not intended to be limiting of any particular implementation for accomplishing and/or performing the actions, steps, processes, etc., attributable to and/or performed thereby. An algorithm, system, module, engine, and/or architecture may be, but is not limited to, software, hardware and/or firmware or any combination thereof that performs the specified functions including, but not limited to, any use of a general and/or specialized processor in combination with appropriate software loaded or stored in a machine-readable memory and executed by the processor.

Further, any name associated with a particular algorithm, system, module, and/or engine is, unless otherwise specified, for purposes of convenience of reference and not intended to be limiting to a specific implementation. Additionally, any functionality attributed to an algorithm, system, module, engine, and/or architecture may be equally performed by multiple algorithms, systems, modules, engines, and/or architectures incorporated into and/or combined with the functionality of another algorithm, system, module, engine, and/or architecture of the same or different type, or distributed across one or more algorithms, systems, modules, engines, and/or architectures of various configurations.

Disclosed herein are modular, user-configurable interfaces that simplify interaction with leak testing systems while maintaining role-specific access controls and promoting efficient operation. The systems and methods can dynamically adapt to a user's role, operational requirements, and real-time leak testing system state, allowing both novice and expert users to interact with the leak testing system efficiently and securely.

The systems and methods described herein provide for pneumatically independent channels, the ability to initiate and terminate tests asynchronously between channels, and support for both wall-mounted and benchtop configurations. The present disclosure introduces innovations in various aspects, including user experience, data analytics, enhanced functionality, modularity, remote support capabilities, advanced temperature compensation, and predictive testing methodologies. Several technical advancements are incorporated into the disclosed system, including, but not limited to, enhanced integration, improved functionality, asynchronous and independent channel operation, and advanced curve analysis.

The systems and methods disclosed herein implement independent channels, support both synchronous and asynchronous operation, optionally include a wall-mountable form factor, have the capability to support a plurality electronic regulators per channel and inclusion of a plurality of high-resolution analog-to-digital converter (ADC) per channel for precise measurements, and have the ability to execute complex programming and sequencing. The disclosed system and methods employ an interchangeable modular architecture to facilitate rapid transitions between different test types and to allow for the substitution of spare channel boxes for calibration and servicing requirements. The fundamental functionality of the exemplary leak tester systems disclosed herein is structured around five primary components: the primary enclosure, the channel box, the pneumatic connection manifold, the test channel controller printed circuit board (TCC PCB), and the backplane PCB.

In some embodiments, the configurable user interface (UI) facilitates flexible control of the leak testing systems and its connected channel boxes. This functionality allows users to view and analyze data resulting from tests based on their specific roles and credentials. The advantages of this GUI arrangement include flexibility in presenting as much or as little data and controls as required for user roles, clarity in associating data with its respective module, and ease of access to essential controls (e.g., displaying correct outputs for barcode scans or restricting program changes for unauthorized users). The disclosed technology addresses technical challenges of navigating extensive regulatory requirements surrounding the validation of leak testing systems by streamlining access to functionality based on user permissions. In some embodiments, the disclosed technology resolves the inefficiency in monitoring test progress by summarizing critical information (such as program status, part batch under test, remaining time, and step information) in an easily-accessible and intuitive manner.

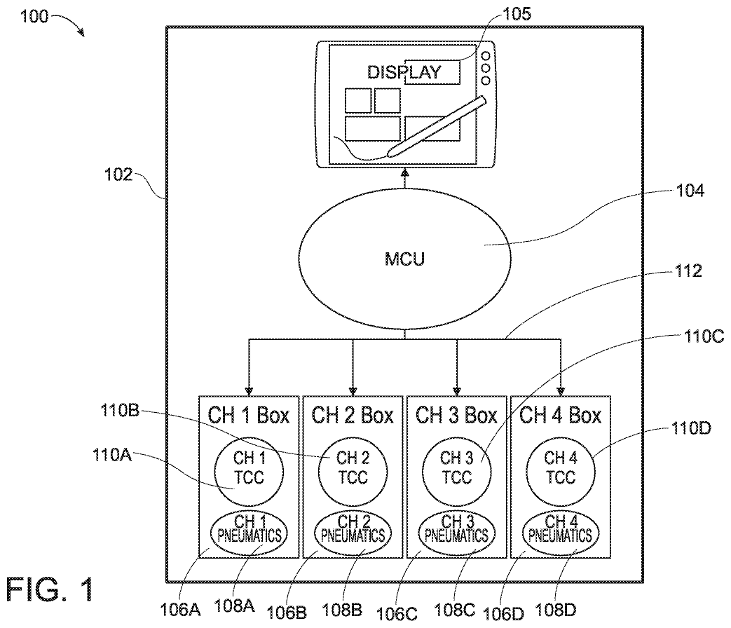

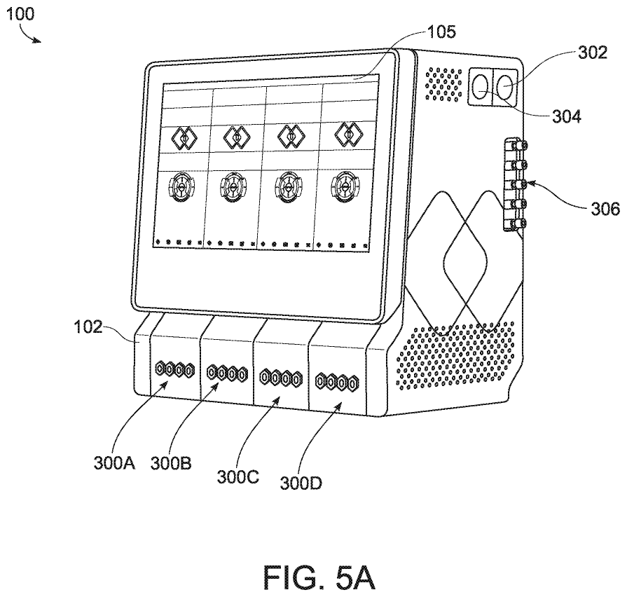

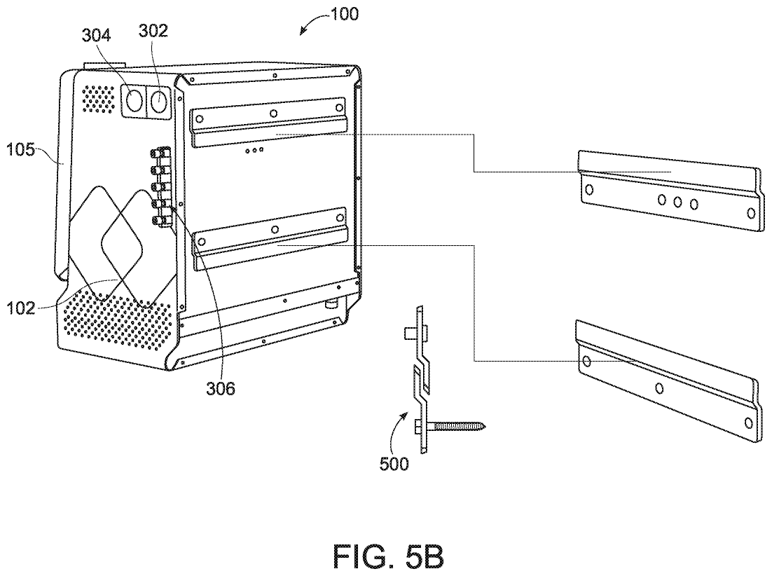

Referring now to FIG. 1, a block diagram of exemplary components of an exemplary leak testing system 100 is illustrated. The leak testing system 100 in this example includes an enclosure 102, which serves as the housing for all functional components and is provided in two form factors: a benchtop configuration and a wall-mounted configuration. FIGS. 5A and 5B depict exemplary wall-mounted configurations in some examples. In the benchtop configuration, the enclosure is positioned on a flat surface. In the wall-mounted configuration, the enclosure is designed to be affixed to a wall by sliding it into place via bracket mechanism 500, ensuring secure attachment while maintaining accessibility for service and operation.

The main control unit (MCU) 104 functions as the onboard computing system. In some embodiments, there is only one MCU per leak testing system. In other embodiments, a plurality of MCUs may be used. The MCU 104 is responsible for communication and control over all channels and global operational settings of the leak testing system 100. As shown, the display 105 comprises a user-facing touchscreen interface positioned on the exterior of the enclosure 102, allowing users to interact with the MCU 104, monitor test operations, and review test results.

Each of the channel boxes 106A-D is a subassembly associated with a testing channel within the leak testing system 100 and contains the channel-specific pneumatic components 108A-D and electronic components. The test channel controllers (TCC) 110A-D in the channel boxes 106A-D are circuit boards designed to interface with the pneumatic components 108A-D and sensors of each channel while executing the test operations for that specific channel. In the illustrated embodiment, each of the channel boxes 106A-D within the leak testing system 100 is equipped with an individual TCC 110A-D with the leak testing system 100 being capable of supporting a plurality of channels. The pneumatic components 108A-D associated with each of the channel boxes 106A-D include, but are not limited to, manifolds, sensors, regulators, and/or valves, all of which are configured to meet the specific pneumatic circuit requirements for the respective channel.

Internal communication between the MCU 104 and each installed TCC 110A-D may be implemented via a digital communication bus 112. This communication channel may be encrypted and/or physically segregated from a customer network to enhance security. In some embodiments, USB is utilized as the primary internal communication protocol, though the leak testing system 100 is designed to support additional communication interfaces, including Ethernet and CANbus. A switch or hub can be integrated within the enclosure 102 to facilitate internal data routing. In some embodiments, peer-to-peer communication between TCCs 110A-D may be supported through Ethernet or CANbus, allowing for direct data exchange between test channels corresponding to the channel boxes 106A-D.

The communication bus 112 is not accessible from the exterior of the enclosure 102 in some examples for general system operation. However, provisions may be included to allow diagnostic or production testing of TCCs 110A-D via this communication bus 112. Additionally, the TCCs 110A-D are designed to support an Ethernet hardware driver and connector.

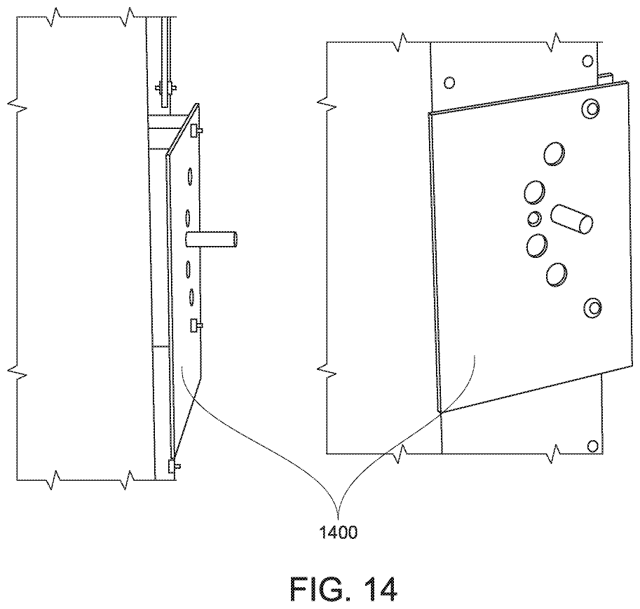

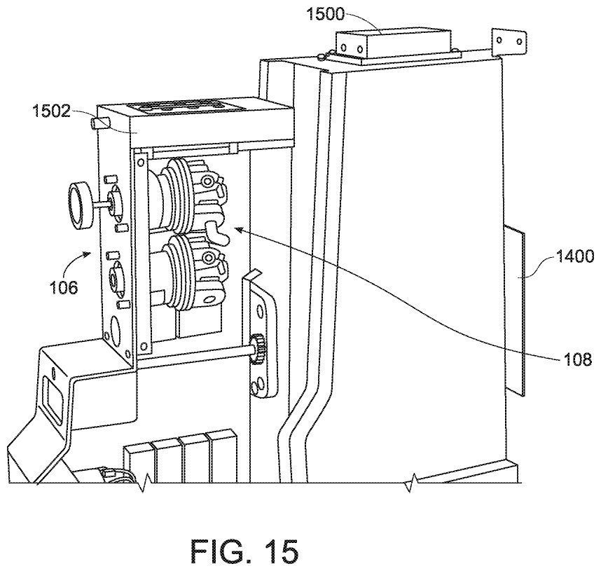

The primary enclosure 102 comprises the backplane printed circuit board (PCB) or backplane board (see FIG. 14) and a pneumatic distribution manifold (see FIG. 15). These components facilitate the rapid replacement of hardware associated with each test channel, allowing for minimal downtime during service events and allowing for flexible production scheduling. In some embodiments, a standby channel box may be substituted, thereby permitting production to resume within a short period while utilizing the same leak testing system 100. The primary enclosure 102 functions as the static element of the leak testing system 100 and, once installed, is designed to remain in place at the end-user site.

The enclosure 102 is designed to support both wall-mounted and benchtop configurations while maintaining consistency across these configurations to reduce inventory requirements, minimize complexity, and facilitate streamlined design maintenance. The enclosure 102 may be configured to allow authorized personnel to access its interior for maintenance or adjustments while remaining securely closed and locked against unauthorized access. As shown, the primary functional components, including the pneumatic components 108A-D, TCC 110A-D, and MCU 104, are housed within the same enclosure 102.

The dimensions of the enclosure are determined by market requirements and the need to accommodate channel boxes 106A-D containing all necessary circuits. A single enclosure 102 may be structured to accommodate all standard configurations. In some embodiments, the maximum enclosure size is specified as 22 inches in width, 22 inches in height, and 9 inches in depth, with minimization of the enclosure 102 dimensions prioritized where feasible.

In some embodiments, the display 105, positioned on the front face of the enclosure 102, is designed to occupy the majority of the available surface area to enhance visual appeal and maximize functional utility. A larger display 105 provides an improved user interface experience, facilitates ease of interaction, and ensures test results and operational information are clearly visible from multiple viewing angles and adjacent workstations.

As shown, each of the channel boxes 106A-D comprises one of the TCCs 110A-D and corresponding pneumatic components 108A-D. The modular channel boxes 106A-D facilitate efficient removal and replacement as a single unit, allowing for streamlined servicing in both field and factory environments. This approach allows for rapid maintenance and replacement, minimizing system downtime.

In some embodiments, access to non-adjustable components within the channel box 106A-D is restricted from the end user to optimize servicing efficiency and ensure the integrity of the leak testing system 100. This approach allows a channel box 106A-D to be serviced or replaced as a single unit rather than requiring individual component adjustments.

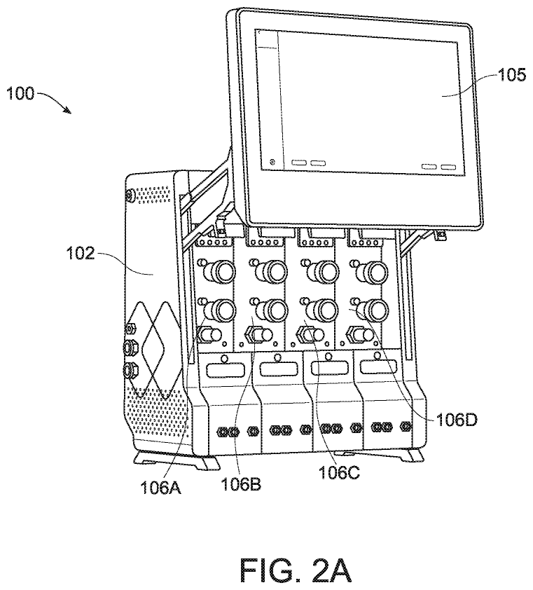

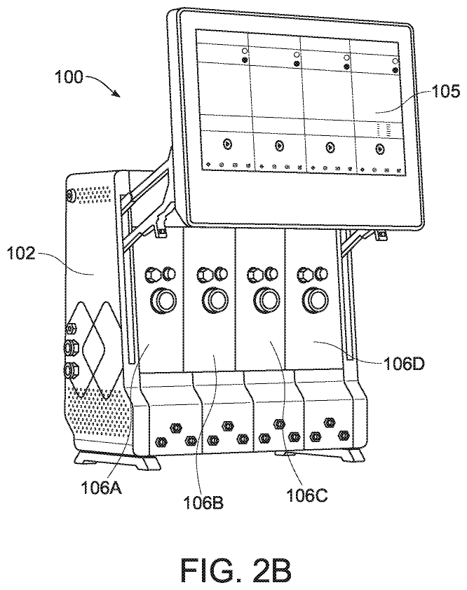

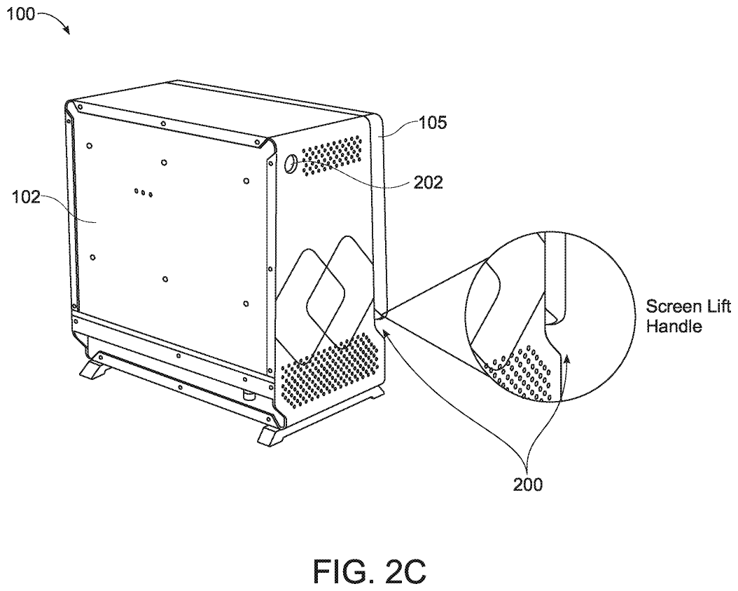

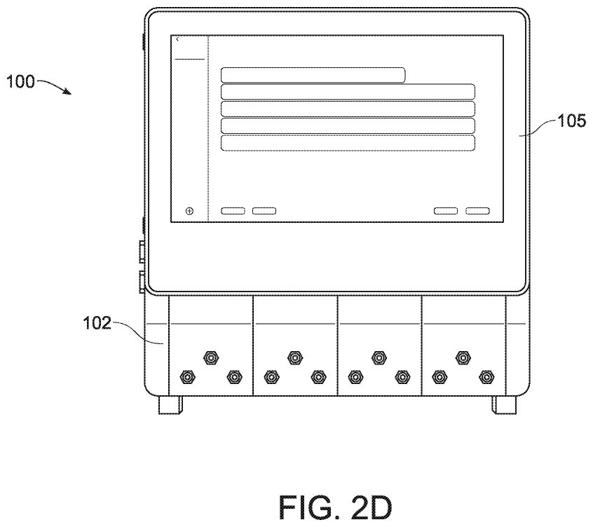

In some embodiments, various elements of the leak testing system 100 are externally accessible while the main enclosure 102 remains closed, as it is depicted in FIG. 2D. These include the touchscreen interface, start and stop buttons, USB ports, power connections, Ethernet connections, discrete digital input/output (I/O) ports per channel, and pneumatic ports, including inlets, exhausts, test ports, and coupling ports, for example, although other configurations can also be used in other examples.

In some embodiments, additional components are accessible when the enclosure is opened, as is depicted in FIGS. 2A and 2B. These include manual regulator knobs and needle valves, which remain visible during adjustments, as well as the leak master unit if an internal calibration option is selected. In some embodiments, the valving is internal, and the leak master is external and is connected to one of the test ports on the front of the corresponding one of the channel boxes 106A-D. Internal pneumatic connections between the channel boxes 106A-D and the supply/exhaust system are also accessible, which may be implemented using cabling or rack/panel connectors.

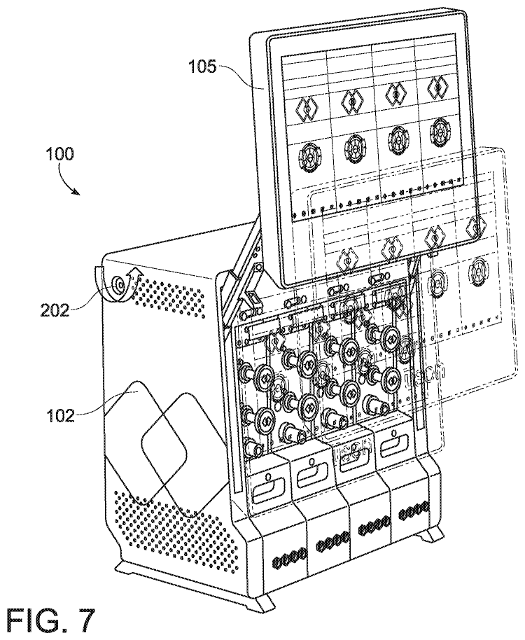

The display 105 of the leak testing system 100 can be hinged to facilitate open and closed positions whereby the display 105 provides access to the channel boxes 106A-D and substantially covers the channel boxes 106A-D, respectively. As illustrated in FIG. 2C, the leak testing system 100 can include a screen lift handle 200 that facilitates the opened and closed positions for the display 105. FIG. 2C also illustrates an optional screen latch override 202, which is also shown in FIG. 7, and releases the hinge such that the display 105 is movable about the hinge to facilitate access to the channel boxes 106A-D.

Electromagnetic interference (EMI) control and shielding is incorporated into the leak testing system 100 to mitigate radiated and absorbed electrical noise. The enclosure 102 is designed to absorb and minimize electromagnetic radiation to ensure compliance with the EMC Directive (2014/30/EU). This shielding reduces radio frequency (RF) emissions and enhances leak testing system 100 stability.

Effective thermal management helps to ensure optimal electronic performance and maintain stable test conditions, particularly for applications sensitive to thermal fluctuations, such as those involving low-volume, low-pressure, short-cycle tests or tests with variable frequency patterns that inhibit temperature stabilization. The maximum internal operating temperature of the leak testing system 100 should not exceed the rated temperature limit of the MCU (60° C. for the SBC-220) or other internal electronic devices, including SD memory, solid-state drives (SSD), and USB hubs.

To enhance thermal performance, components that generate minimal heat, such as low-wattage valves, may be selected where possible. Additionally, the leak testing system 100 may incorporate various heat dissipation mechanisms, including heat sinks and cooling fans, to maintain optimal operating conditions. In some embodiments, a warm-up program may be implemented to accommodate diverse use cases and ensure stable temperature conditions prior to testing.

The backplane PCB functions as the central power and data distribution hub for the leak testing system 100. In some embodiments, the backplane PCB includes a power inlet, switching circuitry, a serial data bus hub, and a microprocessor for controlling leak testing system 100 operations. The backplane PCB also provides a pathway for external communication of input/output (I/O) signals, facilitating efficient data transmission and power management throughout the leak testing system 100.

In some embodiments, the leak testing system 100 requires a single low-voltage output derived from an input power supply of 100-240V AC at 47-63 Hz, which may provide power which complies with the European Union (EU) Low Voltage Directive (LVD) power regulations. In some embodiments, the selected power supply will provide a 24V DC output. A bulkhead connector can be integrated to allow low-voltage DC input power to enter the leak testing system 100. Additionally, an externally accessible power ON/OFF switch is provided for user operation.

In some embodiments, the power-related components are arranged on the same side of the leak testing system 100 and are externally accessible from the enclosure 102. To ensure compliance with power cycling and overload protection requirements, a power-interrupting switch and fuse are integrated into an external panel. The fuse is designed to fail under fault conditions to protect leak testing system 100 components, with the appropriate fuse rating determined based on the leak testing system 100 final design. Following the power entry port, switch, and fuse, the raw DC voltage is processed through an EMI filter to remove electrical noise generated by the leak testing system 100. This filter is selected to meet specific EMC requirements and is positioned in proximity to the other input power components. Each of these power management functions is arranged in sequence before voltage is distributed to various system sub-assemblies.

The leak testing system 100 architecture may support multiple power supplies with varying capacities, allowing for the selection of a heavy-duty power supply for complex configurations. The chosen power supply must be capable of delivering sufficient power to meet the internal demands of a given leak testing system 100 configuration. In some embodiments, worst-case power consumption scenarios include valve drivers requiring up to 9.52 Amps at 24 Volts (228.5 Watts). Additional power demands from user I/O, the MCU 104, an LCD screen display 106, and other TCC 110A-D components must also be considered in the power budget. A comprehensive power estimation, accounting for worst-case and standard operating conditions, is conducted once all leak testing system 100 components have been selected.

In some embodiments, the channel boxes 106A-D serve as modular components of the leak testing system 100, incorporating the TCC 110A-D and the receiving section of the pneumatic connection manifold. The channel boxes 106A-D are configured to be easily interchangeable at an end-user site, facilitating maintenance, calibration, and modifications without requiring extensive system downtime. In some embodiments, the channel box includes various integrated components, such as the TCC 110A-D PCB, process sensors, test ports, pressure regulators, valving, a receiving manifold, connection systems, and a TCC-to-backplane interface connector. The structural design of the channel box ensures compatibility with multiple configurations.

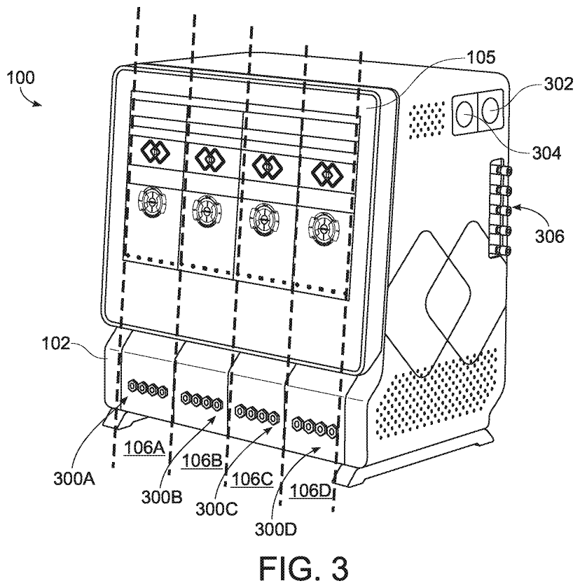

In some embodiments, the leak testing system 100 architecture can support a plurality of independent channels. For example, as depicted in FIG. 3, the leak testing system 100 architecture can support four independent channels (corresponding to channel boxes 106A-D), with each channel incorporating a dedicated TCC 110A-D, although any number of channels or channel boxes can be included in other examples.

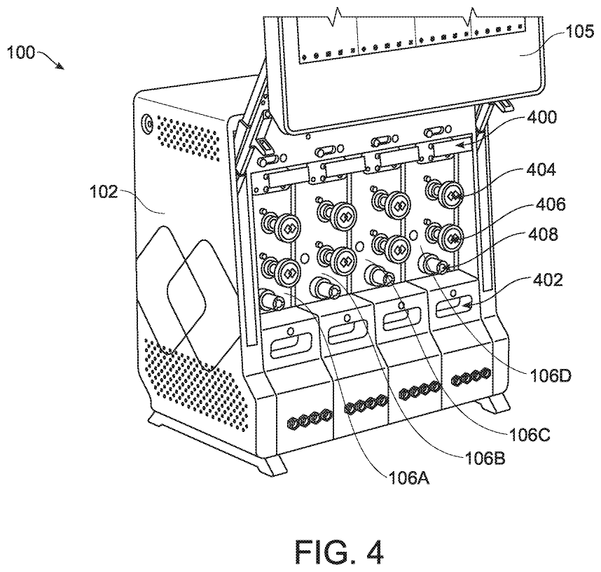

In FIG. 4, a front view of the leak testing system 100 in an opened configuration is illustrated. In this example, the display is raised or opened to reveal the channel boxes 106A-D. The leak testing system in this example also includes a channel box upper carry handle 400, a channel box lower carry handle 402, a primary regulator 404, a secondary regulator 406, and an auxiliary regulator 408. While the primary regulator 404, a secondary regulator 406, and an auxiliary regulator 408 are illustrated with reference to channel box 106D, one or more of the other channel boxes 106A-C can also include a primary regulator, a secondary regulator, and/or an auxiliary regulator 408.

Each TCC 110A-D operates independently from the others, allowing a channel to function distinctly from the other channels in both configurations and test parameters. Thus, each of the channel boxes 106A-D can have an associated set of test ports 300A-D. The leak testing system 100 in this example also includes a couple regulator 302, a couple pressure gauge 304, and a common pneumatic connection manifold 306, which is described and illustrated in more detail below.

In some embodiments, individual channels may be configured to operate under different model types and test types, allowing, for example, a gauge decay model type on one channel and a differential decay model type on another. Each channel is programmed to execute only the test procedures that correspond to its specific configuration, with sensor ranges independently assigned to each channel.

The selection of a model type, test type, or operational option for a given channel is governed by predefined rules and limitations to ensure proper valve state operation and compatibility with standardized testing protocols. In some embodiments, for example, a channel utilizing a decay model type may be required to select between crack testing and sealed component testing, with the leak testing system 100 preventing simultaneous selection of both.

The leak testing system 100 supports two primary modes of operation: asynchronous and sequenced. In asynchronous operation, each channel operates independently, allowing tests to be initiated and terminated separately for each channel. This mode permits independent testing on multiple channels, wherein an operator may load a part on one channel, initiate testing, and subsequently load a part on another channel without waiting for the prior test to conclude. In sequenced operation, multiple channels may be configured to execute a predefined sequence of test programs in a synchronized manner. In some embodiments, the user may define a sequence in which all channels execute a first test program simultaneously, followed by subsequent programs in a coordinated manner. Alternatively, different channels may be assigned distinct test sequences, with one subset of channels executing a first program while another subset executes a different program upon completion of the first sequence. This mode ensures structured and synchronized testing sequences based on predefined parameters.

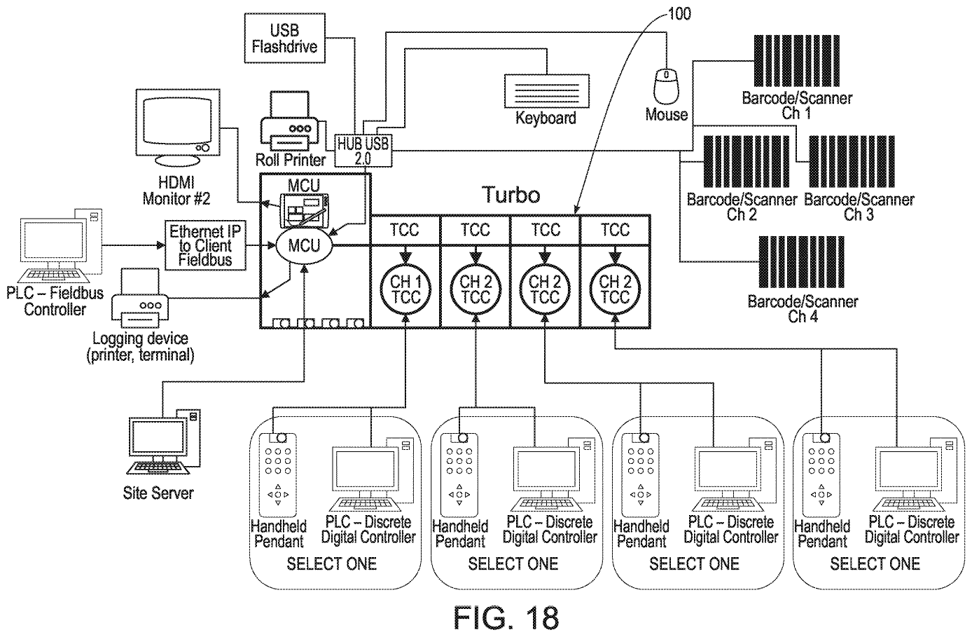

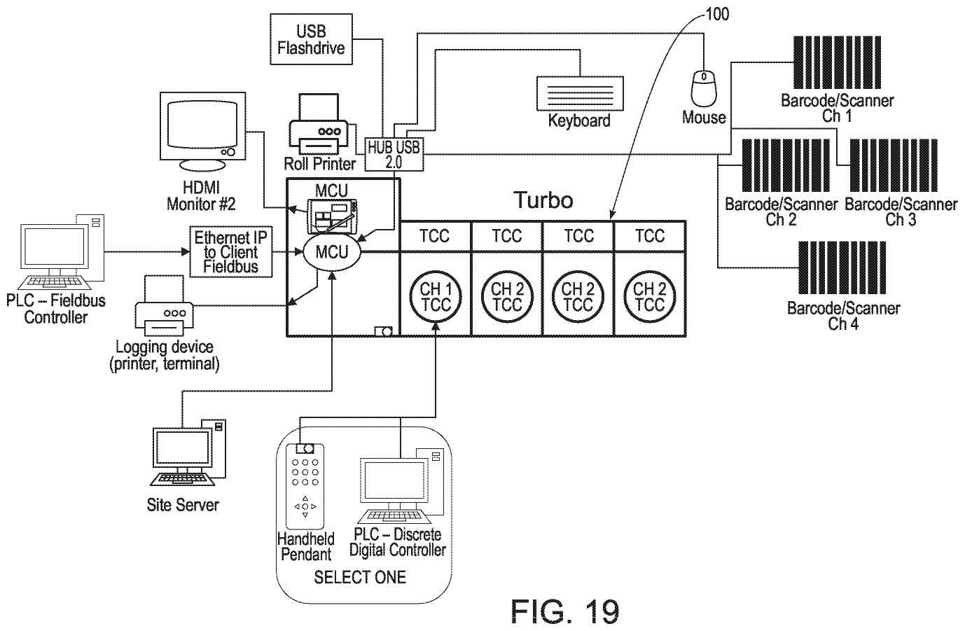

The selected mode of operation may influence the selection of external devices attached to the leak testing system 100, including barcode readers and discrete digital input/output (I/O) remote pendants. FIG. 18 illustrates the leak testing system 100 operation in asynchronous mode, while FIG. 19 depicts the leak testing system 100 configuration in sequenced mode.

The pneumatic connection manifold 306 is divided between the primary enclosure 102, which serves as the distribution unit, and the channel boxes 106A-D, which serves as the receiving unit. This configuration establishes a pneumatic interconnect between the two enclosures, allowing for efficient distribution and control of pressurized media.

A common pneumatic connection manifold 306 is configured to feed all channels within the leak testing system 100. In some embodiments, selectable options allow for the inclusion of up to one high-pressure inlet capable of handling pressures greater than 150 psi and up to 1000 psi, one low-pressure inlet accommodating pressures of 150 psi or lower, and one external vacuum inlet.

In some embodiments, selectable options allow for the inclusion of a high-pressure inlet capable of handling pressures ranging from 500 psi to 1000 psi, a medium-pressure inlet capable of handling pressures ranging from 150 psi to 500 psi, a low pressure inlet capable of handling pressures ranging from 0 psi to 150 psi, an external vacuum supply, and a regulated couple air supply capable of handling pressures of up to 125 psi.

Each channel is equipped with an independent pneumatic supply circuit, including its associated components. In some embodiments, each channel may include one main regulator, which may be either manually adjusted or electronically controlled, one auxiliary manual regulator, and an internal vacuum generation circuit.

In the illustrated embodiment, the system architecture supports up to four high-resolution ADCs per channel, facilitating precise pneumatic measurements. The pneumatic configuration supports standard and high-flow valving, with pressure ranges extending from vacuum to 1000 psi and flow capacities reaching up to 100 liters per minute (Lpm). In some embodiments, the pneumatic configuration can support pressure ranges exceeding 1000 psi and flow capacities exceeding 100 Lpm. In some embodiments, up to two coupling valves per channel may be controlled.

The leak testing system 100 provides external pneumatic ports, with the number and function of test ports varying according to the model type, test type, and selected configuration options. In some embodiments, two coupling ports, corresponding to two coupling valves per channel, may be supported.

The distribution manifold, located within the primary enclosure 102, is configured with input ports that accommodate multiple pressure levels and flow directions. This distribution manifold integrates a mechanism that allows multiple valves to be actuated simultaneously using a singular tooling motion. This feature facilitates the controlled supply and venting of pressure to and from the channel boxes 106A-D as part of the connection and ejection process. All available pressure levels are routed through this distribution manifold. Additionally, interlocks are incorporated to prevent unintended or unsafe operation.

The receiving manifold, housed within each of the channel boxes 106A-D, is responsible for distributing the applied pressures received from the distribution manifold. Any pressures not required for a specific test are blocked within the receiving manifold. This receiving manifold is also designed with structural provisions to secure its attachment to the distribution manifold, ensuring a leak-tight seal. Upon disengagement, the receiving manifold triggers the closing of the distribution manifold valves and vents any residual downstream pressure, thereby facilitating a controlled and safe disengagement process. In some embodiments, the closing/venting of the distribution manifold is completed before undocking the receiving manifold. In some embodiments, the user first de-energizes the distribution manifold, then the user can disengage the receiving manifold.

The TCC 110A-D PCBs are integrated into each channel box 106A-D and are responsible for managing all functional operations of the channel box 106A-D and the associated testing processes. The primary functions of the TCCs 110A-D include receiving and processing sensor inputs, performing A/D conversion, managing internal and external isolated input signals, and high-side drivers. Additionally, the TCCs 110A-D are equipped with a microprocessor, firmware storage, and interfaces that allow for the transmission of power and data between the TCCs 110A-D and the backplane PCB. The TCCs 110A-D serve as the fundamental operational unit of the leak testing system 100, executing all test-related functions while exchanging data bidirectionally with the MCU 104.

The TCC 110A-D PCBs are configured to operate independently within each channel, operating the corresponding valves, electronic regulators, and sensors. In some embodiments, the TCC 110A-D PCBs are designed to minimize activation energy and redesign time, enhancing leak testing system 100 efficiency.

The TCC 110A-D PCBs include a power-on self-test (POST) functionality to detect TCC 110A-D properties and determine the number of attached TCCs 110A-D PCBs. To ensure the integrity and security of firmware execution, the leak testing system 100 may implement error correction mechanisms or cyclic redundancy checks (CRC) for validation. Additionally, the leak testing system 100 provides indications of successful boot completion and communication status via USB, RS232 messaging, or onboard LED indicators.

Each TCC 110A-D PCB is assigned a unique identifier, such as a serial number or a universally unique identifier (UUID). If an Ethernet port is present, the media access control (MAC) address may also be utilized. This identifier is programmed into the TCC 110A-D PCBs prior to operation to permit the MCU 104 software to identify, enumerate, and correctly associate each TCC 110A-D with the appropriate channel. In some embodiments, the programming of TCC 110A-D identification may be completed by a contract manufacturer (CM), with potential support provided by engineering or production teams during the initial setup phase.

In some embodiments, the leak testing system 100 supports a variety of valve configurations, with power consumption per channel depending on the number of valves and test parameters. Across different test scenarios, the power demand per channel typically ranges from 14 W to 57 W, with current draw ranging between 0.58 A and 2.38 A at 24V DC. Higher-powered configurations, such as high-pressure burst testing, require the upper end of this range. The leak testing system 100 can accommodate this range while ensuring efficient power distribution and thermal management.

In some embodiments, the TCCs 110A-D are required to support analog interfaces for measuring and controlling devices that utilize analog input and output signals. The characteristics of these interfaces, including resolution, accuracy, voltage and current range, gain, and filtering, are determined by the leak testing system 100 specifications. Since the TCCs 110A-D are digital control systems, analog interfaces are implemented using analog-to-digital (A/D) and digital-to-analog (D/A) conversion components.

The leak testing system 100 is configured to support a range of pressure sensors to ensure compatibility with various testing applications. In some embodiments, at a minimum, the system is designed to support a range of gauge pressure sensors and differential pressure sensors. Flow sensors are incorporated to facilitate precise measurement of fluid flow during testing operations. In some embodiments, the leak testing system 100 supports a range of mass flow sensors selected based on their prevalence and demonstrated performance in similar applications.

The TCCs 110A-D are further configured to electrically interface with force sensors to allow force measurement in applicable testing scenarios. In some embodiments, alternative force sensors that utilize the same millivolt analog input may also be supported, subject to further determination based on leak testing system 100 design considerations.

The leak testing system 100 is designed to support multiple temperature measurement points to monitor and compensate for temperature variations during testing. In some embodiments, a diagnostic temperature measurement is incorporated within the TCCs 110A-D, with a requirement that it does not necessitate a high-resolution ADC. Additionally, an internal temperature measurement is provided within the channel boxes 106A-D, optionally located within the manifold or another critical area, also without the need for a high-resolution ADC. Further, an external temperature measurement is implemented, with a preference for digital sensor data acquisition via an RS485 communication interface.

The leak testing system 100 architecture includes support for electronic pressure regulators (EPR) and electronic flow controllers, with each of the TCCs 110A-D capable of accommodating one such device per channel. The operation of these components is achieved through control via an analog voltage signal, which is generated using a digital-to-analog (D/A) converter and an amplifier. In some embodiments, at a minimum, each of the TCCs 110A-D is configured to electrically support various electronic pressure regulators.

Each of the TCCs 110A-D is configured to support additional digital signals to enhance system safety, monitoring, and operational efficiency in some examples. In some embodiments, the TCCs 110A-D include a pressure switch that detects insufficient pilot air supply or a loss of air supply. This pressure switch is operably connected to a safety valve, which functions to lock air within the couple circuit and prevent unintentional state changes. The implementation of this safety mechanism may be achieved through hardware or software, with hardware-based solutions being preferable from a safety perspective.

Furthermore, in some embodiments, the leak testing system 100 incorporates a spool position sensor within the combination valve assembly. This sensor is configured to detect instances where the equalization valve fails to actuate properly, thereby generating an error signal that is communicated to the operator. Additionally, provisions may be made to support at least one sensor with a digital interface via an RS485 communication protocol. This configuration may facilitate external sensor integration, such as temperature compensation measurements or the transmission of sensor data from an external processing unit.

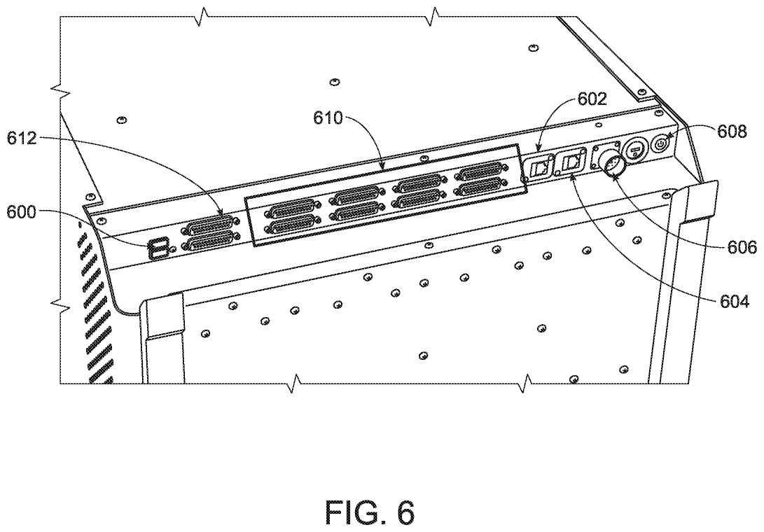

A rear view of an exemplary leak testing system 100 is illustrated in FIG. 6. The leak testing system 100 in this example includes USB ports 600, an RJ45 TCP-/IP input 602, an RJ45 PLC bus 604, a power supply connector 606, and a power switch 608. In some embodiments, as depicted in FIG. 6, the leak testing system 100 provides 16 discrete channel-specific (for each channel) I/Os 610 plus 16 discrete I/Os 612 for global control. The discrete digital I/O is based on a 24V DC hardware interface implementation and is externally accessible to the operator. The digital I/O may be utilized by external devices, including PLCs or remote pendants, to facilitate program and sequence selection, initiate and abort tests, and communicate test results and leak testing system 100 status.

In one embodiment, the leak testing system 100 provides fixed I/O assignments for predefined functions. However, in some embodiments, a customizable configuration may be implemented, allowing the end user to modify the default I/O assignments. The leak testing system 100 may be configured to support program and sequence selection, using a binary-coded decimal (BCD) format or using a binary format.

Each output in the exemplary leak testing system 100 is configured to operate at 0.7 A, with a total output capacity of 4 A. These outputs are implemented as high-side 24V DC sources with integrated protection to ensure leak testing system 100 stability and prevent overcurrent conditions. In some embodiments, when BCD program selection inputs are user-defined, the leak testing system 100 is configured to manage and control the assigned code weighting. This may be accomplished by automatically assigning BCD outputs in an ascending order (e.g., BCD 1, BCD 2, etc.), or by providing a secondary field allowing the user to define the assignment of BCD 1 through BCD 8. The salvage output selection is not required in the present implementation. However, the leak testing system 100 is designed to support alert outputs for operational status and fault indication. In some embodiments, a custom configuration option may be provided, which includes an “Apply Defaults” feature, allowing users to revert to predefined settings.

In some embodiments, the system further includes a timer verification output, which is implemented as a 24V high-side sourcing output to ensure consistency with other output configurations. The reliability of all input and output connections is a critical aspect of overall leak testing system 100 performance. Therefore, the leak testing system 100 incorporates a robust connector design with built-in cable support and strain relief to enhance durability and maintain secure electrical connections. To support these functionalities, a total of twenty-five contacts is required for each standard I/O configuration, including both power and ground connections, resulting in 25 input signals and 25 output signals. In some embodiments, if the input and output connections are separated into distinct connectors, it may be advantageous to implement output signals on a socketed panel component, while input signals are connected via pin-type interfaces to facilitate reliable and secure connectivity.

The following input/output assignments are provided as examples and are intended to be non-limiting. These configurations can be adjusted and customized as needed based on specific user requirements and system needs.

TABLE 1
Inputs

| # | Standard: Default | Custom: Default Selection |
|---|---|---|
| Input | Selection - Fixed | (Fixed or User defined) |
| 1 | Start | Start (Fixed) |
| 2 | Start Enable | Start Enable (Fixed) |
| 3 | Abort | Abort (Fixed) |
| 4 | Program Select 1 | Program Select 1 (User |
| | | Defined) |
| 5 | Program Select 2 | Program Select 2 (User |
| | | Defined) |
| 6 | Program Select 3 | Program Select 3 (User |
| | | Defined) |
| 7 | Program Select 4 | Program Select 4 (User |
| | | Defined) |
| 8 | Program Select 5 | Program Select 5 (User |
| | | Defined) |
| 9 | Program Select 6 | Program Select 6 (User |
| | | Defined) |
| 10 | Program Select 7 | Program Select 7 (User |
| | | Defined) |
| 11 | Program Select 8 | Program Select 8 (User |
| | | Defined) |
| 12 | Disabled | Disabled (User Defined) |
| 13 | Disabled | Disabled (User Defined) |
| 14 | Disabled | Disabled (User Defined) |
| 15 | Disabled | Disabled (User Defined) |
| 16 | Disabled | Disabled (User Defined) |

TABLE 2
Input Select Options

| Option | Controlled By | Ch # |
|---|---|---|
| Disabled | — | — |
| Start | Channel/Sequencer | —/x |
| Start Enable | Channel/Sequencer | —/x |
| Stop | Channel/Sequencer | —/x |
| Abort | Channel/Sequencer | —/x |
| BCD X Selection | Channel/Sequencer/Group | —/x |

TABLE 3
Outputs

| # | Standard: Default | Custom: Default Selections |
|---|---|---|
| Output | Selections - Fixed | (Fixed or User defined). |
| 1 | Alarm | Alarm (user defined) |
| 2 | Ready | Ready (User defined) |
| 3 | EOC | EOC (User Defined) |
| 4 | Timer | Timer (User Defined) |
| 5 | Pass | Pass (User Defined) |
| 6 | Fail | Fail (User Defined) |
| 7 | Disabled | Program Specified (User |
| | | Defined) |
| 8 | Disabled | Program Specified (User |
| | | Defined) |
| 9 | Disabled | Program Specified (User |
| | | Defined) |
| 10 | Disabled | Program Specified (User |
| | | Defined) |
| 11 | Disabled | Program Specified (User |
| | | Defined) |
| 12 | Disabled | Program Specified (User |
| | | Defined) |
| 13 | Disabled | Program Specified (User |
| | | Defined) |
| 14 | Disabled | Program Specified (User |
| | | Defined) |
| 15 | Disabled | Program Specified (User |
| | | Defined) |
| 16 | Disabled | Program Specified (User |
| | | Defined) |

TABLE 4
Output Selection Options

| Option | Controlled By | Ch # | Type. |
|---|---|---|---|
| Disabled | — | — | |
| Alarm | Channel | — | |
| Ready | Channel/Sequencer | —/x | |
| EOC | Channel/Sequencer | —/x | |
| Timer Verification | Channel | — | |
| Result | Channel | — | Pass, Fail, Gross, Fast |
| | | | Flush, Roll Over, Step |
| | | | Pass, Step Fail, Link |
| | | | Pass, Link Fail |
| | Sequencer | X | Group Pass, Group |
| | | | Fail, Seq Channel |
| | | | Pass, Seq Channel |
| | | | Fail, Seq Pass, Seq |
| | | | Fail. |
| Program Specified | Channel/sequencer | X | BCD X Selection, |
| | | | where Vis 0 to 9 |
| Alarm | Channel | X | |
| Ready | Channel/Sequencer | —/x | |
| EOC | Channel/Sequencer | —/x | |
| Pass Mark | Channel/Sequencer | —/x | |
| Consecutive Reject | Channel/Sequencer | —/x | |
| Couple | Channel/Sequencer | —/x | Couple 1, couple 2, |
| | | | couple 3, couple 4 |
| Alert | — | — | |

Communication between the TCCs 110A-D and the MCU 104 is implemented via USB in some examples. Additionally, support is provided for Controller Area Network (CAN) bus and Ethernet communication, allowing for future development and expansion. The system architecture includes provisions for integrating components necessary to support all three communication protocols. An internal USB adapter is required to facilitate connectivity; however, a host function is not necessary for this implementation.

Automatic detection of channel box 106A-D locations is incorporated through a hardware-based mechanism. The physical arrangement of channels is fixed such that Channels 1, 2, 3, and 4 are aligned sequentially from left to right, corresponding to the touchscreen display's channel numbering. The leak testing system 100 is configured to automatically identify the connection position of each of the channel boxes 106A-D, and consequently, each TCC 110A-D, within the enclosure 102. Upon detection, the assigned channel position is displayed to the user through the system interface.

The firmware for each of the TCCs 110A-D is stored and executed locally on the TCC 110A-D hardware. In some embodiments, the firmware is stored in either a microSD card or serial flash memory. To ensure data security and prevent unauthorized modifications, the firmware requires encryption. The leak testing system 100 architecture is designed such that, in future implementations, the firmware may be adapted to support additional capabilities.

A menu-driven manufacturing test capability is provided to verify the proper operation of each of the TCCs 110A-D before it is connected to the MCU 104. The manufacturing test functionality includes a user-selectable mode that allows for detailed validation of all critical TCC 110A-D functions as well as any additional tests required by system engineering teams. These tests may include, but are not limited to, memory integrity verification, power stability assessment, and functional validation of analog and digital input/output interfaces.

To facilitate manufacturing and validation, dedicated test equipment, including test boxes, software tools, and additional fixtures, are utilized. The testing process supports connection through either the USB or RS-232 interface, allowing for flexible configuration and debugging. The manufacturing test system is designed to verify all relevant system-level performance parameters, including power supply voltage stability, ADC readings, solenoid valve activation states, and the toggling functionality of critical control signals.

The MCU 104 is configured to facilitate the operation, monitoring, and management of the leak testing system 100. As shown, the MCU 104 incorporates a touchscreen display 105 that provides a user interface for test configuration and setup information associated with the TCCs 110A-D. The MCU 104 includes software-based controls for initiating and terminating test operations. A single serial port may be implemented as a 9-pin D-type connector to allow data logging and, if necessary, debugging operations.

The MCU 104 features an Ethernet-based IT network connection that supports program import/export functionality and allows test results to be logged to an external Windows-based server. Furthermore, a dedicated industrial network connection is provided for communication with a PLC over a fieldbus protocol. This connection allows remote access to data, facilitates program and sequence selection, allows for the initiation and termination of tests, and provides result and status outputs to external control systems. The MCU 104 also includes two externally accessible USB ports 600.

The exemplary leak testing system 100 architecture permits multiple selections for results logging, including but not limited to logging via USB storage devices, network-based storage, or a serial connection. In some embodiments, the MCU 104 is configured to support an external secondary monitor, which can be connected via an HDMI port, allowing for the mirroring of the primary display for enhanced visualization and operational monitoring.

The MCU 104 may support the use of barcode scanning devices to facilitate test initiation, program selection, and data input. In some embodiments, either a single barcode scanner is utilized for the entire leak testing system 100, or multiple barcode scanners (up to four, one per channel) are implemented. Where multiple barcode scanners are employed, a unique prefix identifier, such as ‘A’, ‘B’, ‘C’, or ‘D’ is assigned to each scanner to differentiate the corresponding test channel.

The leak testing system 100 architecture supports the storage of multiple sequences within the MCU 104, with no defined limit of distinct sequences that may be configured and stored. In some embodiments, the MCU 104 is capable of storing up to and exceeding, for example, 1,000 distinct test programs and an equivalent number of test sequences. Functionality is provided to allow for the duplication and modification of existing programs. The MCU 104 is further designed with an expansion slot, which may be configured as either a mini-PCIe or M.2 slot, to support potential future system enhancements requiring additional PC-based cards.

External communication from the MCU 104 is facilitated through multiple interfaces. The primary user interface includes a front-panel touchscreen display that provides access to start/stop controls, test programs, and configuration settings. The touchscreen is designed with an optically bonded protective glass overlay and incorporates capacitive touch functionality, including gesture-based controls. In some embodiments, the display 105 specifications range from 18.5 inches to 21.5 inches in diagonal measurement, with a resolution of 1920×1080 pixels and an aspect ratio of 16:9.

In some embodiments, the MCU 104 includes a dedicated Ethernet port for industrial fieldbus communication, establishing connectivity with external PLC systems. This interface supports fieldbus communication protocols, allowing for seamless integration with industrial automation systems. Additionally, a translation device may be employed to facilitate communication with other fieldbus protocols. In such embodiments, the MCU 104 transmits data via Ethernet/IP or Modbus TCP to an intermediate converter, which subsequently translates the communication protocol to match the PLC's required format, such as Profibus, Profinet, EtherCAT, or DeviceNet.

In some embodiments, Modbus TCP/IP may be natively supported. The inclusion of Modbus TCP/IP may facilitate compatibility with other communication protocols while maintaining system performance. Furthermore, this implementation may enhance backward compatibility with existing systems that rely on Modbus communication.

In some embodiments, a dedicated Ethernet port is provided for connectivity to an IT network, allowing for the logging of test results and the export of data to a Windows-based server. The functionality of the Ethernet connection, including features related to data transfer and security, may be selectively enabled or disabled through software configuration settings.

A single externally accessible RS232 serial port is included to support customer requirements for connecting a serial printer or terminal, allowing for real-time viewing or printing of test results. The exemplary leak testing system 100 also incorporates two externally accessible USB 3.0 ports 600 on the enclosure, which facilitate connectivity with external devices for data transfer, software updates, and peripheral expansion.

In some embodiments, provisions may be included to support future capabilities related to exporting, viewing, and potentially modifying system data, including test programs and configuration settings, through a dedicated application or viewer. The system can also be designed to accommodate an external USB hub, which may be either optional or user-supplied, thereby increasing the number of available USB ports when required.

The installation process for a channel box 106A-D into an empty bay follows a structured sequence to ensure proper alignment and secure connection. Initially, the channel box is positioned onto a guide block and pushed rearward. Upon reaching a damper, alignment pins are piloted into the channel boxes 106A-D. Continued rearward movement proceeds until a firm stop is encountered. At this stage, a tool is utilized to rotate a connection fastener located on the handle of the channel box 106A-D, drawing it fully into the bay. The fastener is rotated until hand-tightened to ensure a secure mechanical connection. Subsequently, the same tool is used to rotate the pneumatic connection actuator, positioned at the upper left of the channel box, until it reaches its stop position. This action facilitates the connection of the pneumatic manifolds and ensures full engagement of the channel box 106A-D box within the bay.

Following the mechanical and pneumatic engagement, the pneumatic supply is activated using the same tool to actuate the distribution manifold supply valve. This valve is interfaced via a mating connection situated above the one of the channel boxes 106A-D at the top of the primary enclosure. Once actuated, pressure is applied to the one of the channel boxes 106A-D, allowing it to function within the leak testing system 100. Upon completion of these steps, the one of the channel boxes 106A-D is fully installed, securely connected, and fully energized for operation.

The disclosed leak testing system 100 is designed to serve various markets, including but not limited to medical devices, industrial applications, packaging, automotive and transportation, and electric vehicle manufacturing. The system is capable of operating with multiple testing media, including air and nitrogen, among other suitable alternatives. The leak testing system 100 supports a diverse range of test types, including but not limited to pressure decay, mass flow, occlusion testing, and seal creep testing. These testing capabilities are configured to address complex and varied application requirements.

The disclosed leak testing system 100 enhances conventional product offerings by extending functionality and improving automation integration. The measurement engine is expanded to accommodate additional test techniques suitable for complex applications. Automation features are improved to provide greater configuration flexibility, facilitating seamless system integration. Data analytics capabilities are enhanced to support robust analysis, while the user experience is optimized to ensure scalability across research and development (R&D) environments and high-volume production settings.

The measurement engine is configured to support an increased number of test types, including differential pressure decay testing. In some embodiments, the leak testing system 100 is designed to accommodate extended applications involving high-pressure testing exceeding 1000 psi, high-flow testing, and distinct test types per channel. Additional sensor capabilities are incorporated, with expanded sensor ranges and increased sensitivity to ensure precise measurements.

The exemplary leak testing system 100 architecture supports synchronous and asynchronous operation while maintaining digital I/O functionality. In some embodiments, the fieldbus communication system is upgraded from Modbus to a faster, modern Ethernet/IP-based or other fieldbus architecture. The modular design is implemented in both wall-mounted and benchtop form factors.

The automation capabilities of the exemplary leak testing system 100 include multiple modes of operation, such as sequence mode, asynchronous mode, and synchronous mode. The modular architecture supports different form factors, including wall-mounted and benchtop configurations. Improved I/O control is incorporated, along with native fieldbus integration to facilitate enhanced automation and connectivity.

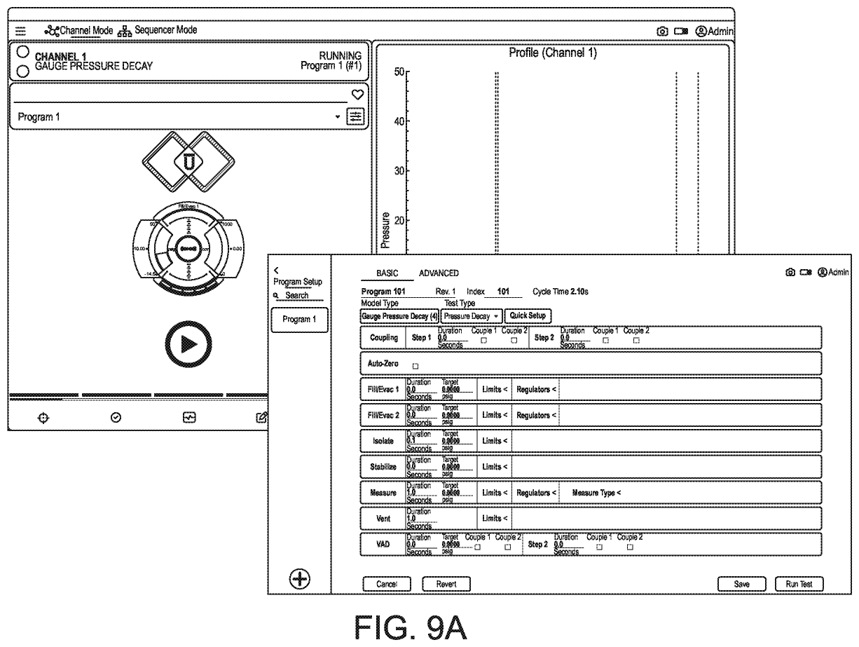

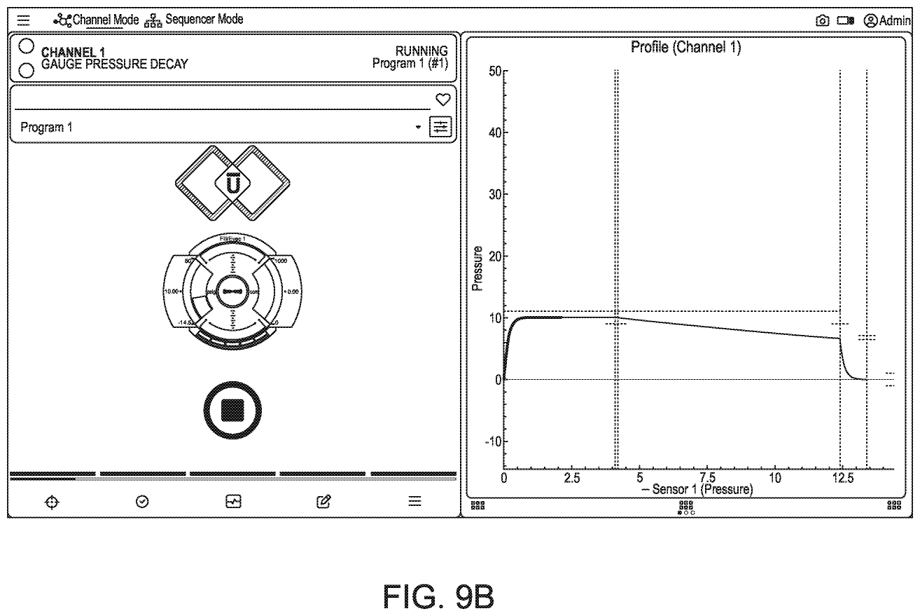

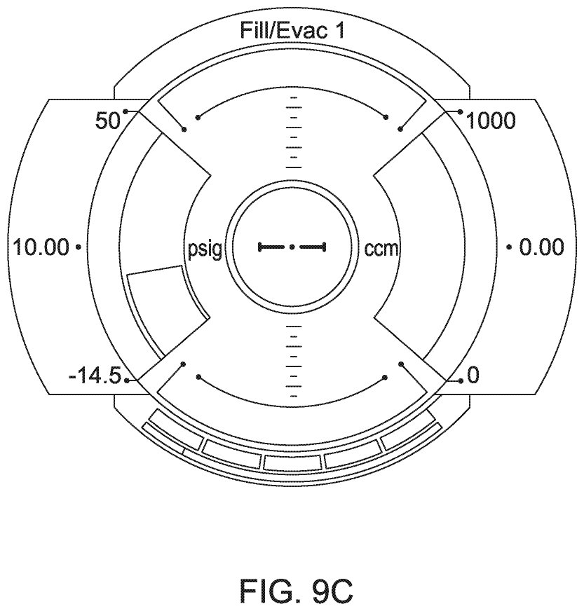

The data analytics functionality may be designed to support pneumatic channel independence and expanded graphing capabilities, allowing for advanced data visualization and interpretation. The user interface, as depicted in FIGS. 9A-C, is developed to provide an enhanced user experience, featuring a flexible home page with configurable widgets and a large multi-touch display. The setup process is streamlined to improve efficiency, while plot functionality is enhanced to facilitate test data review and analysis. The leak testing system 100 architecture is restructured to support independent channels, thereby increasing operational flexibility.

In some embodiments, the leak testing system 100 includes a larger touchscreen display 105 to provide an optimized user interface. The restructuring of the architecture ensures improved support for independent channel operations. The home screen configuration is made more flexible, allowing for customization based on user preferences. The program setup process is simplified and streamlined to enhance overall usability.

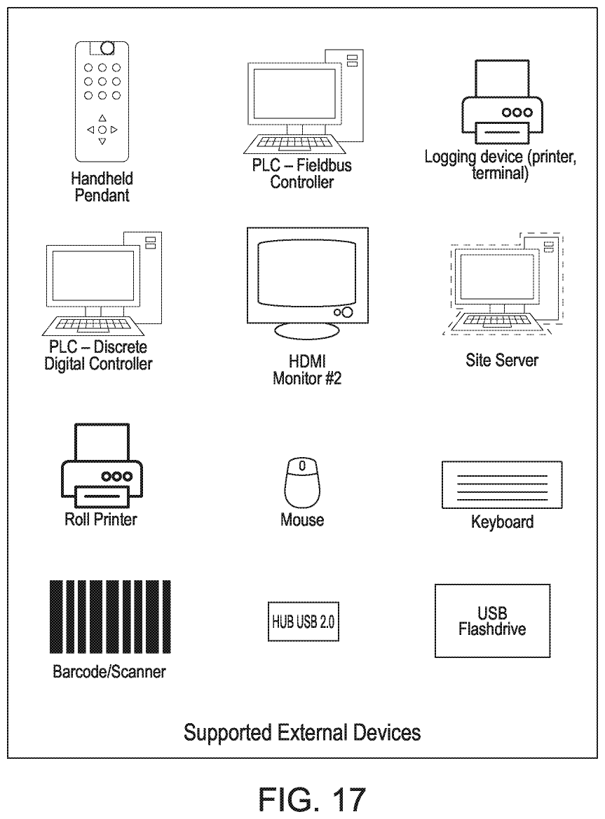

FIG. 17 illustrates exemplary supported external devices that can be connected to the leak testing system 100, encompassing multiple categories of devices that facilitate enhanced functionality and leak testing system 100 integration. The leak testing system 100 supports external devices interfacing through USB, digital I/O connections, Ethernet, HDMI, and RS232 serial ports. These devices allow for advanced user interaction, data logging, test initiation, and automation integration.

In some embodiments, a barcode reader is implemented for scanning data, selecting programs, and initiating test procedures. The barcode reader configuration supports two primary options: a single reader per tester or individual readers assigned per channel. When a single barcode reader is used per tester, the signal is transmitted via USB to the MCU 104. Alternatively, when each channel is assigned a dedicated barcode reader, the signal is routed through a USB hub to the MCU 104. The MCU 104 is configured to recognize and associate each barcode reader's signal with the corresponding channel based on its unique identifier.

A USB flash drive may be supported for transferring data to and from the leak testing system 100. This includes, but is not limited to, result logging, license updates, and software upgrades. In some embodiments, a keyboard and mouse may be connected to facilitate user interaction with the leak testing system 100 user interface. Additionally, an external USB hub may be supplied by the user if the number of USB-connected devices exceeds the two externally available USB ports on the enclosure. A USB printer may be supported by the operating system's generic driver and may be connected as an optional device. This printer allows for the direct printing of test results from the leak testing system 100.

The leak testing system 100 may support remote pendants that may be utilized for program and/or sequence selection, test start/stop functionality, and status indication. In asynchronous operation, a remote pendant may be assigned per channel. In such embodiments, the TCC 110A-D updates pass/fail outputs when configured, allowing pass/fail indicators to visually reflect the status of the connected channel. In sequenced operation, a single remote pendant may be assigned to leak testing system 100, connected to the leak testing system 100 global I/O 612. The pass/fail outputs of the sequences are updated accordingly and may be configured to display the sequencer's pass/fail status.

In some embodiments, a PLC may be connected directly to the leak testing system 100 discrete digital I/O 610. This configuration allows external PLCs to initiate and terminate tests, select programs, and retrieve status information, providing an alternative automation control method. In some embodiments, a PLC may be utilized for automation control by interfacing directly with the TCCs 110A-D through discrete digital I/O connections. The PLC may be configured to initiate and terminate test procedures, select programs, and retrieve status information from the leak testing system 100. This functionality allows for seamless integration of the leak testing system 100 with industrial automation infrastructure.

The illustrated leak testing system 100 architecture includes externally accessible Ethernet ports to facilitate data communication and control. A first Ethernet port is designated for connection to an external site server, while a second Ethernet/IP port is allocated for fieldbus communication. To prevent misconfiguration, the two ports are physically distinct and may be labeled accordingly. For example, a first Ethernet port may allow for connectivity to a customer's internal site server or network. This connection supports result logging, database import and export, and other data exchange functionalities. In some embodiments, direct transmission of test data to a network printer may not be supported in the initial implementation phase. For example, a second Ethernet port may be allocated for fieldbus communication with a PLC. This connection allows a PLC to transmit and receive operational commands, monitor test execution, and retrieve test results. The fieldbus communication protocol may be based on Ethernet/IP, ensuring compatibility with standard industrial automation systems.

The leak testing system 100 may further include an externally accessible HDMI port, which is configured to support mirrored display functionality for demonstration purposes. In some embodiments, this HDMI output may be utilized exclusively for sales demonstrations, allowing the primary user interface display 105 to be replicated on a secondary monitor. Additionally, the leak testing system 100 may incorporate an externally accessible RS232 serial port for data logging and printing applications. In some embodiments, this port may be used to connect a serial printer or terminal, allowing real-time viewing and printing of test results. The RS232 interface provides a standardized method for external devices to access test data in a structured format.

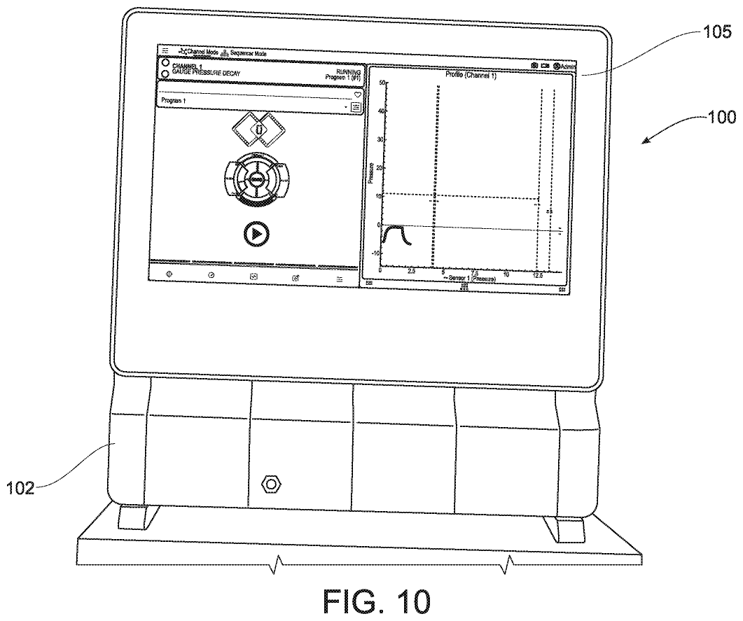

FIG. 10 illustrates a primary enclosure 102, which constitutes the static portion of the leak testing system 100 that is shipped to the customer. As shown, the enclosure 102 is configured to accommodate up to four channels, with a UI positioned on the front panel to facilitate leak testing system 100 operation.

In the illustrated embodiment, the leak testing system 100 architecture includes several components. The front panel is equipped with a touchscreen display 105, which serves as the primary means of interaction between the user and the leak testing system 100. The touchscreen interface allows for test programming, leak testing system 100 control, and real-time visualization of test results.

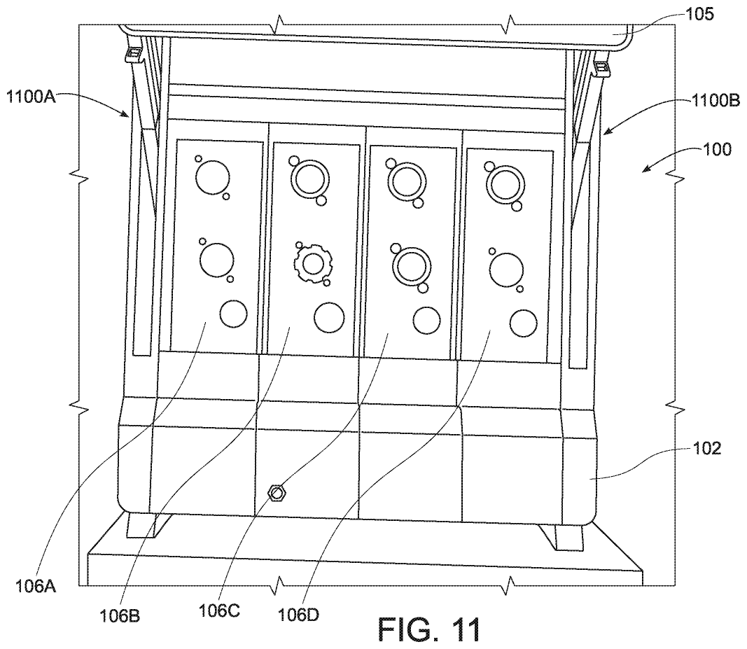

FIG. 11 depicts the leak testing system 100 access mechanism, which allows authorized personnel to open the enclosure 102 for maintenance or modifications. Access to the enclosure 102 is regulated through the user interface, with specific permissions required for entry, as described and illustrated in more detail below. The leak testing system 100 is equipped with one or more electronic latches 110A-B positioned on either side of the enclosure 102 to restrict unauthorized access. In some embodiments, a mechanical override mechanism (as described herein with reference to FIG. 7) is provided to permit access in the event of a power failure or other emergency conditions. The access control functionality ensures that only users with the appropriate authorization can disengage the electronic latches 1100A-B and open the enclosure 102. Upon gaining access, the modular channel boxes 106A-D become visible and accessible for adjustment of leak testing system components 100 (e.g., pneumatic components 108A-D) within the enclosure 102.

As shown, one example of this leak testing system 100 architecture supports up to four channel boxes 106A-D, which are designed to operate within a modular framework. Each channel box 106A-D is a discrete subassembly that may be configured with different functional components depending on specific testing requirements. The modular design allows for flexible positioning of channel boxes 106-D within the enclosure 102, with no restrictions on placement. Spare channel boxes may be maintained on-site to facilitate rapid replacement, thereby minimizing leak testing system 100 downtime. In some embodiments, if a channel box 106A-D requires calibration, modification, or replacement, the existing unit may be removed and a spare unit may be installed in its place. This configuration enhances leak testing system 100 uptime by allowing for quick substitution without requiring extensive service interruptions.

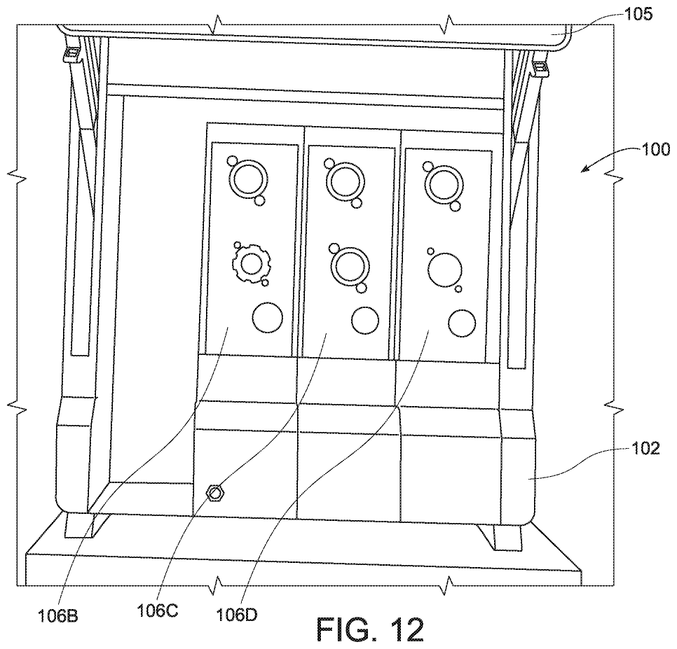

FIGS. 9B-9C illustrates the removal of a channel box 106C from the leak testing system 100 and FIG. 12 illustrates a leak testing system 100 with a channel box 106A removed. The removed channel box 106A may be sent for modifications, calibration, or servicing while a spare channel box is installed in its place. This modular approach ensures that the leak testing system 100 remains fully functional during the transition, thereby minimizing or nearly eliminating downtime.

The rear section of the enclosure 102 incorporates a backplane board, which functions as the conduit for electrical communication and power distribution. This backplane board establishes connectivity between the onboard computing unit (e.g., MCU 104) and the electronics within the channel boxes 106A-D, facilitating seamless communication and control.

The main enclosure 102 also integrates pneumatic connections, which are positioned on the side of the leak testing system 100 for user access. These connections allow for the application of supply pressure to the leak testing system 100. In some embodiments, the pneumatic connections support multiple pressure ranges, allowing the leak testing system 100 to accommodate a variety of testing requirements, including vacuum conditions and pressures up to and exceeding 1000 psi. The leak testing system 100 is designed to permit precise pressure application to each of the channel boxes 106A-D based on its configured pressure range. Additionally, the enclosure 102 includes a rear connection bay that houses various interfaces, including an Ethernet port for fieldbus communication, power connections, a power button, and digital I/O ports. These interfaces allow external control of the leak testing system 100 via a PLC or remote pendant. The power inlet is also positioned at the rear of the enclosure 102, ensuring an organized and centralized access point for leak testing system 100 power management.

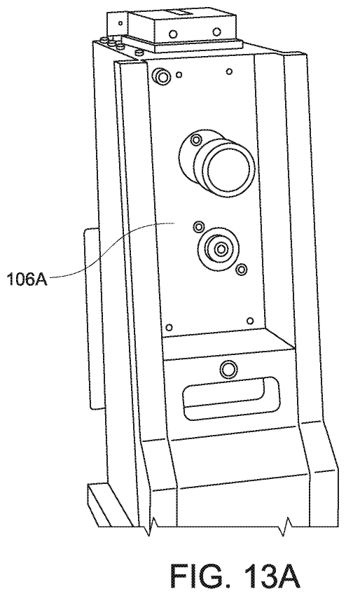

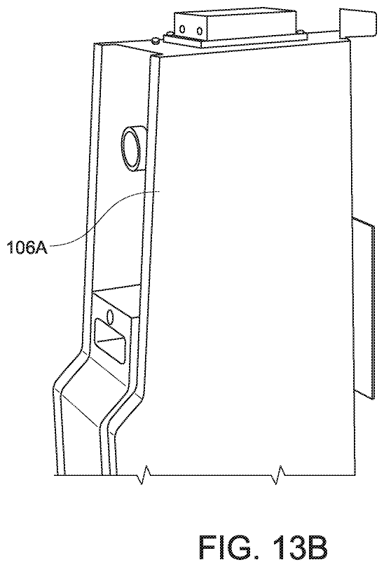

FIGS. 13A-B depict a single channel box 106A extracted from a four-bay enclosure 102 (e.g., as illustrated in FIG. 12), illustrating the structural configuration of the channel box 106A within the static portion of the leak testing system 100.

As illustrated in FIG. 14, the backplane board 1400 functions as the primary conduit for electrical communication and power distribution. This backplane board 1400 serves as the interface between the power inlet of the leak testing system 100 and the electronics within the channel boxes 106A-D, facilitating seamless data transmission between the channel boxes 106A-D and the single-board computer (SBC) of the leak testing system 100.

FIG. 12 depicts an enclosure with the screen raised, revealing four docked channel boxes. The pneumatic docking mechanism is located at the top of the assembly. The distribution manifold, which is positioned within the main enclosure, is configured to mate with a corresponding receiving manifold inside the channel box.

The pneumatic supply connections from the external system deliver compressed air to the distribution manifold, which is designed to allocate the supplied pressures to individual channel boxes 106A-D. The receiving manifold inside each of the channel boxes 106A-D is responsible for regulating the transmitted pressures, determining which pressure levels are directed into the internal pneumatic system of the respective channel. The configuration of the receiving manifold is dependent on the specific requirements of the channel boxes 106A-D, ensuring compatibility with various test applications.

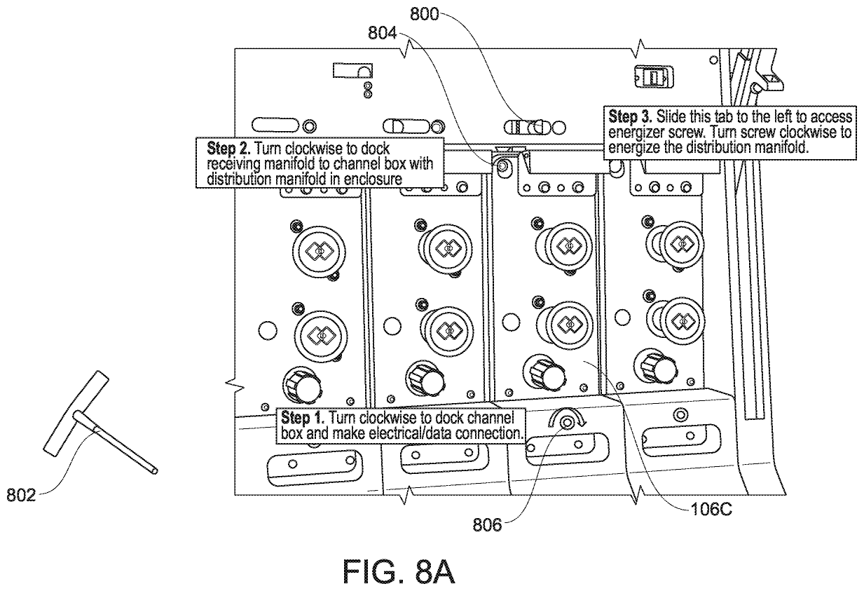

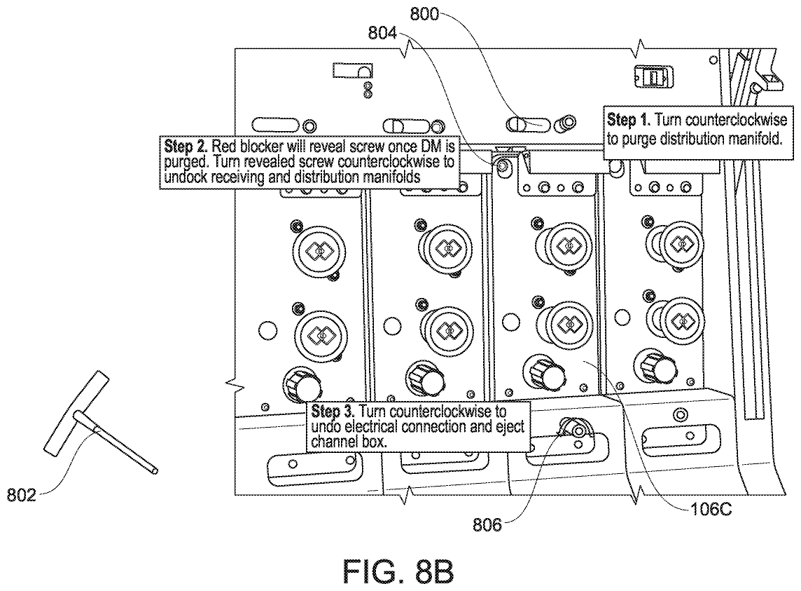

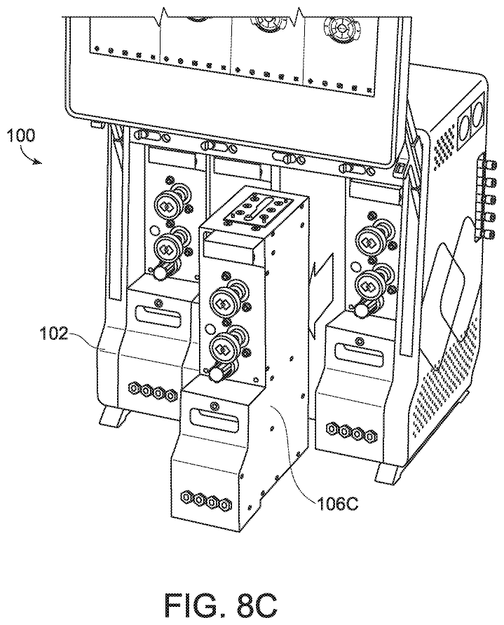

FIGS. 8A-C illustrate the sequence of operations required to undock and dock the channel box 106C detailed herein. The undocking process follows a predefined order to ensure system safety and prevent unintentional pressurization.

The docking and undocking processes are governed by a sequential mechanism that enforces a structured order of operations to ensure proper engagement. Initially, the electrical connections at the rear horizontal docking interface must be fully secured. Once these electrical connections are established, the application of pressure is restricted until the pneumatic docking process is completed. In some embodiments, once electrical docking takes place, while the channel box 106C may be powered and communicating with the leak testing system 100, the channel box 106C may not be able to run tests until the pneumatic docking process is completed. Upon the successful engagement of the pneumatic docking mechanism, the leak testing system 100 may then be energized.

During the undocking process, this order of operations is reversed to ensure a controlled disconnection sequence. The system must first be de-energized, followed by the disengagement of the pneumatic docking mechanism at the upper section of the channel box. Only after these steps have been executed can the horizontal docking mechanism at the rear be released, providing for the removal of the channel box from the system.

As depicted in FIG. 8B, the first step in the undocking sequence involves engaging lead screws 800 using a hex tool 802, thereby initiating the de-energization of the leak testing system 100 or purging of the distribution manifold. This step ensures that leak testing system 100 pressure is shut off and residual pressure is vented, placing the leak testing system 100 in a safe state. Once depressurization is complete, the pneumatic docking mechanism, which is oriented vertically, is disengaged. A red blocker will reveal lead screw 804 once the distribution manifold is purged, which is turned counterclockwise to undock receiving and distribution manifolds. Then, the lead screw 806 is engaged to undo the electrical connection. Subsequently, the horizontal docking mechanism at the rear of the channel box 106C is released, allowing the unit to be fully undocked.

Once the horizontal docking mechanism is disengaged, the channel box 106C can be removed from the enclosure 102, as illustrated in FIG. 8C. The removal of the channel box 106C may be performed for various purposes, including maintenance, calibration, modification, or component upgrades. The modular architecture of the leak testing system 100 permits a rapid substitution of a replacement unit, minimizing downtime and ensuring operational continuity.

As depicted in FIG. 8A, the first step in the docking sequence involves engaging lead screw 8060 make the electrical and data connections. In a second step, the lead screw 804 is engaged to dock the receiving manifold to the channel box 106C with the distribution manifold in the enclosure 102. In a third step, a tab is slid to the side to reveal energizer or lead screw 800, which is engaged to energize the distribution manifold.

FIG. 15 provides a side view of the leak testing system 100, illustrating the internal components of a channel box 106. As described previously, the pneumatic distribution manifold 1500 supplies pressurized air to the receiving manifold 1502 located within the channel box. The receiving manifold 1402 is responsible for directing the appropriate pressures into the pneumatic components 108 of the channel box 106.

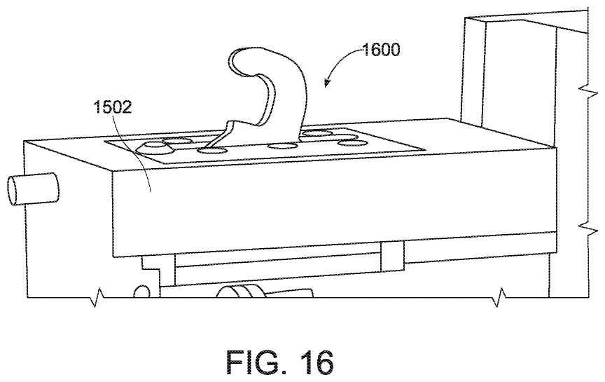

FIG. 16 further illustrates the engagement mechanism between the distribution manifold 1400 and the receiving manifold 1402. A draw latch 1600 is employed to elevate the receiving manifold 1402, ensuring a secure face seal between the two components. The receiving manifold 1402 determines which pressure levels are transmitted into the leak testing system 100, thereby ensuring precise pressure regulation. The pneumatic docking system, inclusive of the pneumatic connection manifold facilitates interchangeable deployment and rapid servicing.

The channel box 106 may further include several components, including the electrical connection system, which facilitates docking at the rear of the enclosure 102. The TCC 108, which serves as the dedicated circuit board for the channel box 106, is housed within this the channel box 106. The TCC 108 is responsible for storing configuration-specific data, processing sensor analog signals, executing test operations, and controlling the operation of valves. The TCC 108 ensures the precise execution of test sequences.

Additionally, the channel box 106 contains downstream pneumatic components 108, including independent, dedicated pressure regulators. The pneumatic components 108 are structured to accommodate various operating pressures. For example, if the leak testing system 100 receives an overall pneumatic supply pressure of 165 psi, but a specific one of the channel boxes 106A-D is configured to operate at 60 psi, the integrated regulator within the one of the channel boxes 106A-D adjusts the pressure accordingly. The channel box 106 also incorporates all channel-specific sensors, valves, and other pneumatic elements necessary for executing the respective test.

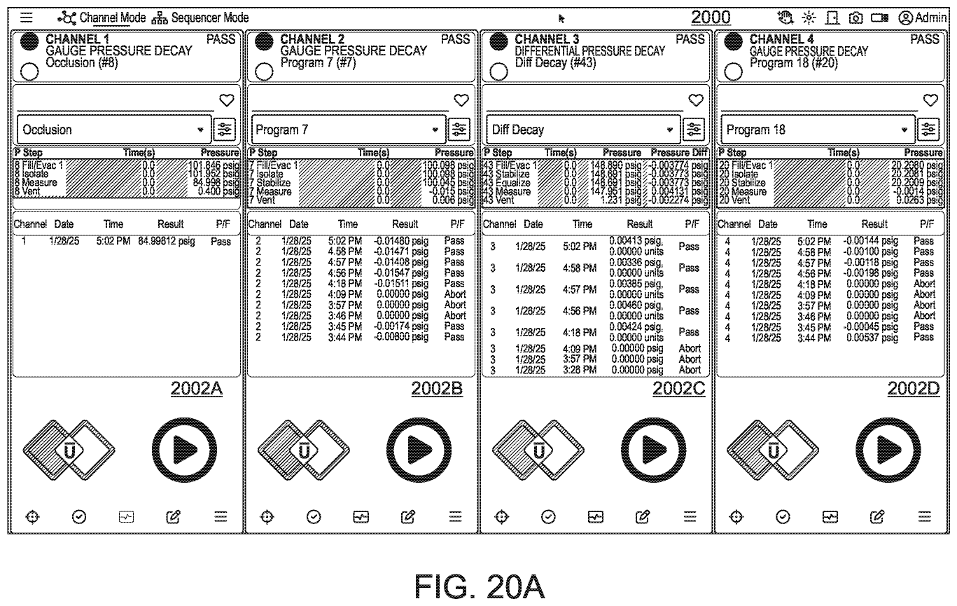

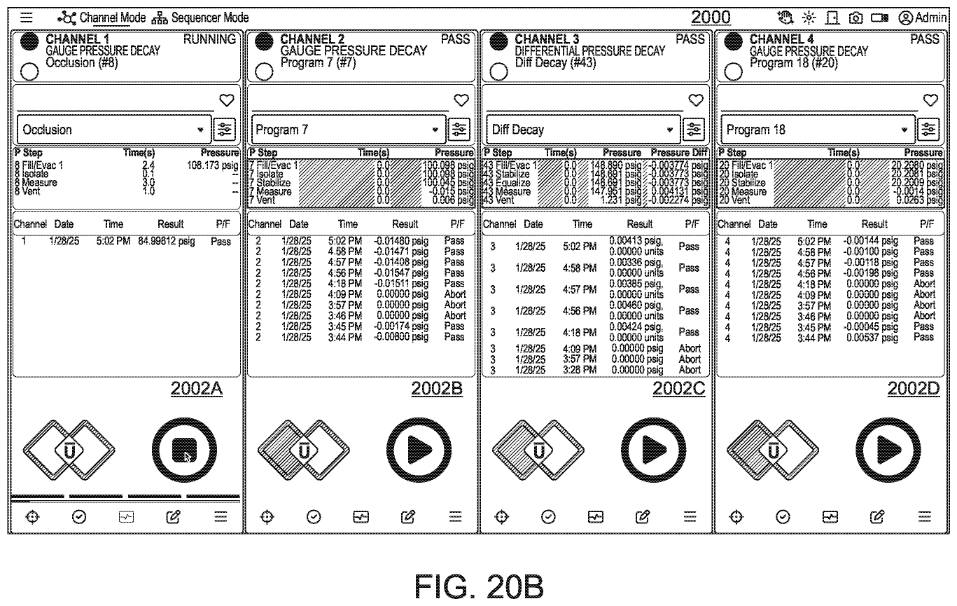

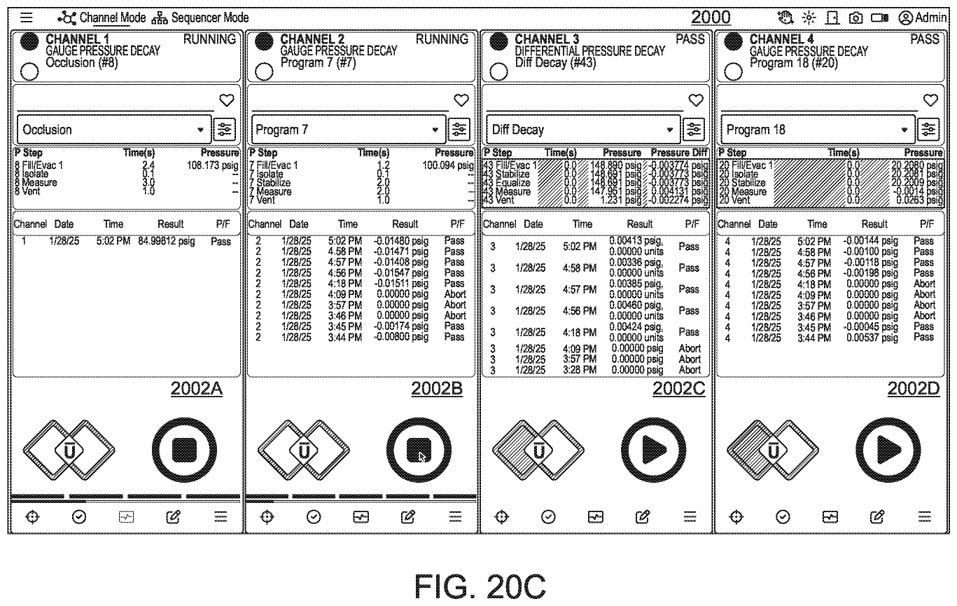

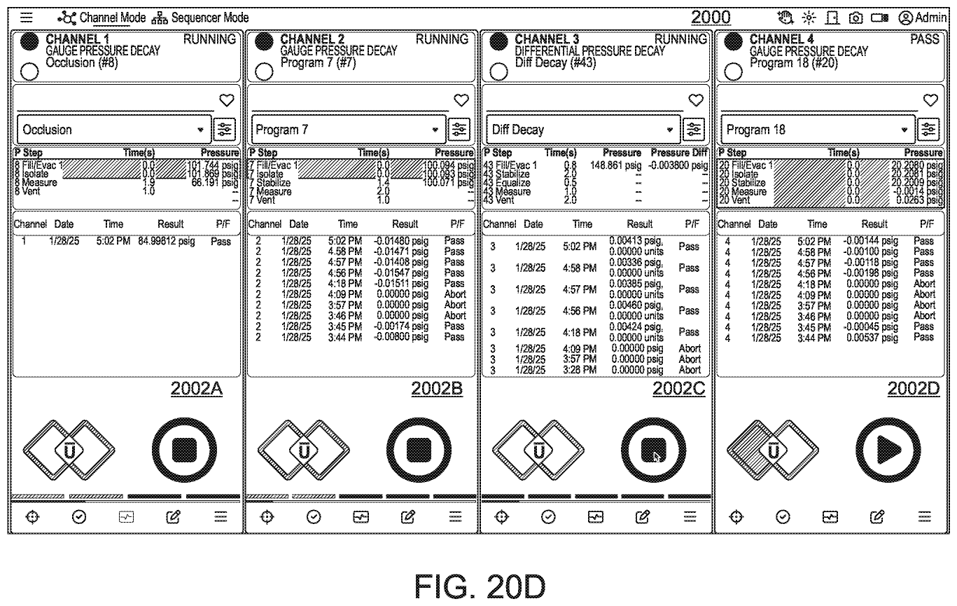

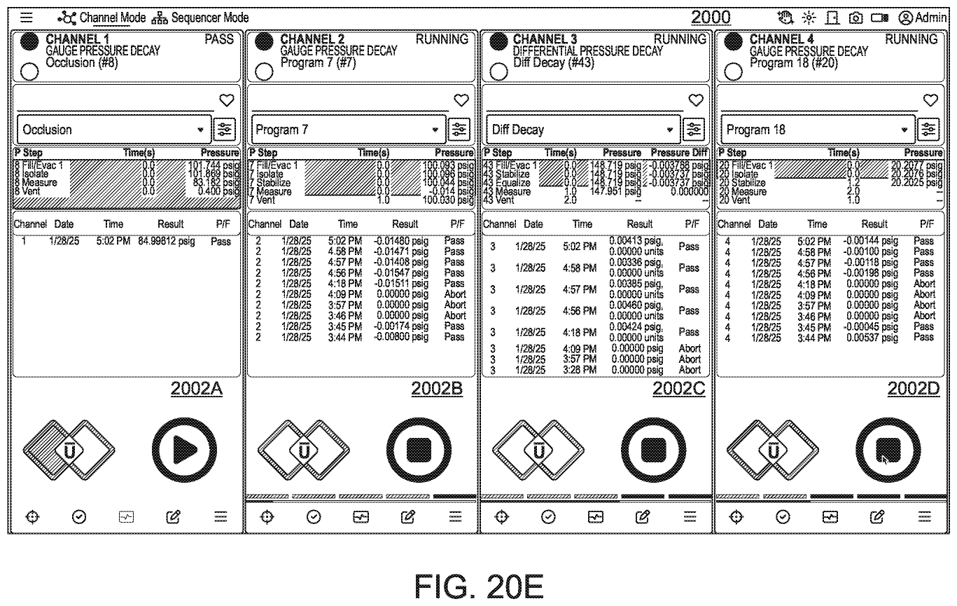

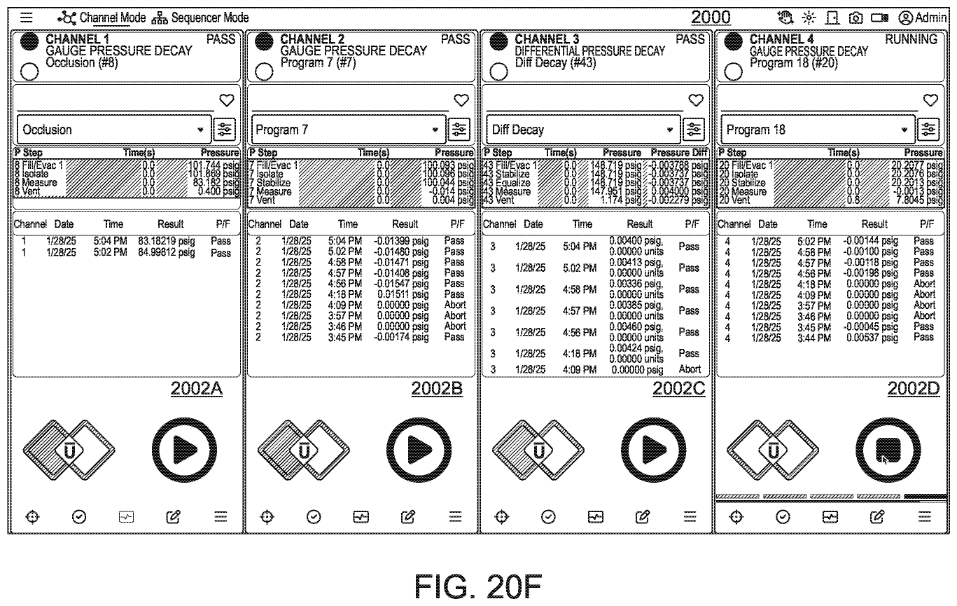

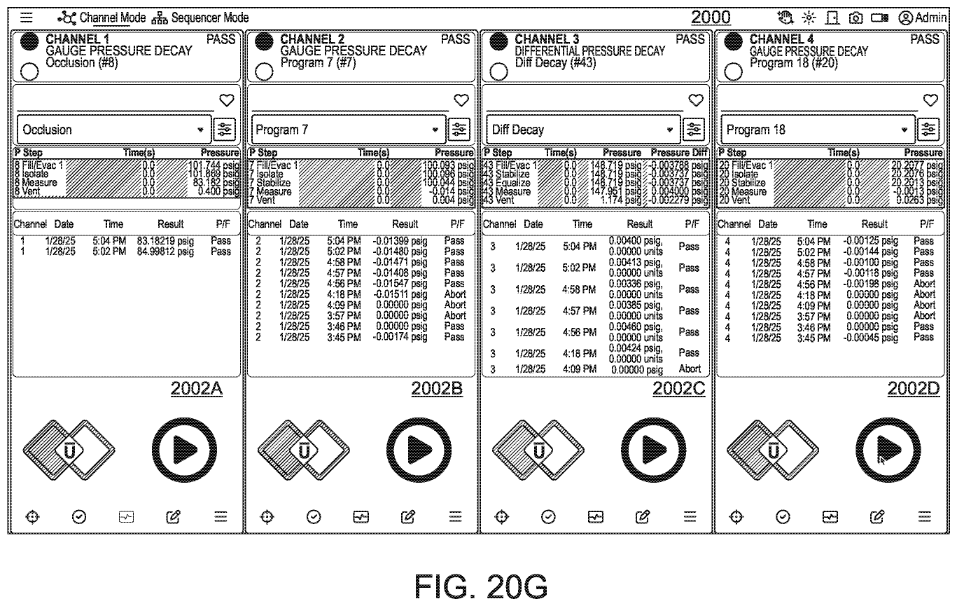

The data analytics functionality of the exemplary leak testing system 100 disclosed herein may be designed to support pneumatic channel independence and expanded graphing capabilities, allowing for advanced data visualization and interpretation. The exemplary user interfaces of the leak testing system 100, as depicted in FIGS. 3, 5A, 9A-C and FIGS. 20-43, for example, provide an enhanced user experience, featuring a flexible home page with configurable widgets and a large multi-touch display 105. The setup process is streamlined to improve efficiency, while plot functionality is enhanced to facilitate test data review and analysis. The leak testing system 100 architecture supports independent channels, as explained in detail above, thereby increasing operational flexibility.

In some embodiments, the leak testing system 100 includes a relatively large touchscreen display 105 to provide an optimized user interface. The architecture ensures improved support for independent channel operations. The home screen configuration is flexible, allowing for customization based on user preferences. The program setup process is simplified and streamlined to enhance overall usability. Thus, the disclosed leak testing system 100 includes a modular and customizable user interface that is designed to facilitate user interaction while adapting to the specific needs of the logged-in user, their role, and the leak testing system 100 state. This modular user interface enhances usability by ensuring that only the most relevant controls, indicators, and data outputs are displayed at any given time.

The exemplary user interfaces of the leak testing system 100, which are described and illustrated in detail below with reference to FIGS. 20-31, are structured into dedicated sections (also referred to as panes or apertures), with each section corresponding to an individual functional leak testing system 100 channel (each corresponding to one of the channel boxes 106A-D). These sections provide configurable and resizable functional elements that adjust dynamically based on the active testing channel, the leak testing system 100 state, and/or the user's permissions. The modular design of the user interface allows specific functional elements to be included, excluded, resized, or repositioned as required.

The leak testing system 100 in some examples supports role-based user interface customization, which ensures that the user interface presents appropriate controls and indicators according to the access privileges of the user. For example, an admin has full leak testing system 100 access and is capable of modifying all configurations, accessing service functions, and overriding test parameters. A supervisor may be able to review results, adjust non-critical settings, and manage test programs. Operators may be restricted to executing predefined test sequences and monitoring test progress. System administrators can be responsible for IT-related management, such as network settings and data export configurations. Service technicians can have limited access to diagnostic and maintenance tools. The user's role can be managed based on a login procedure and stored roles associated with login credentials, for example.

The modular user interface may offer a range of functional elements, which can be assigned to different sections based on user needs and specific leak testing system 100 configurations. These functional elements include a start/abort button that provides direct control over initiating and terminating tests, a multi-functional gauge that displays real-time sensor readings such as pressure, flow, or leak rate, and an accept/reject indicator that signals test pass or fail status based on programmed criteria. Additionally, the user interface provides a digital I/O status to display the active states of external digital input and output signals, a holding register display for showing real-time numerical data used in ongoing test procedures, and a progress bar to visually indicate the completion status of the test cycle.

Further functional elements may include a process curve display that graphically represents live and historical test data, such as pressure decay, flow rate trends, and response curves. A tabulated step results section displays detailed test step outcomes in tabular form for review and analysis. Additionally, a program selection interface allows users to choose and load predefined test programs.

The configurability of these elements enables users to create a personalized testing interface tailored to their workflow. For instance, an operator might only see essential start and abort buttons as well as pass and fail indicators, while a supervisor would have access to program selection options and detailed step result data. Similarly, a service technician could view additional diagnostic data, such as valve activation states and system health indicators, which are necessary for maintenance tasks.

The modular user interface may be optimized to adjust dynamically based on the current leak testing system 100 state. For example, during leak testing system 100 calibration, the user interface may emphasize gauge readings and process curves, whereas in production mode, it prioritizes start controls, status indicators, and pass/fail outputs. In error conditions, the user interface highlights diagnostic tools and troubleshooting recommendations to assist users in resolving issues efficiently. This adaptive and modular user interface architecture advantageously enhances operational efficiency, reduces human error, and ensures that each user interacts with the leak testing system 100 in a manner that is best suited to their role and the current test conditions.

In some examples, the leak testing system 100 includes the channel boxes 106A-D each comprising a TCC 110A-D and pneumatic components 108A-D, wherein each of the TCCs 110A-D is configured to perform a different test procedure using the pneumatic components. In the examples, the enclosure 102 is coupled to a display device 106 and houses memory having instructions stored thereon and also houses the MCU 104. The enclosure 102 is configured to separately receive each of the channel boxes 106A-D and thereby pneumatically couple the channel boxes 106A-D to the enclosure 102. The MCU 104 is coupled to the memory, communicably coupled to the TCCs 110A-D when the channel boxes 106A-D are received by the enclosure, and configured to execute the stored instructions to generate, provide to the display 105 (also referred to herein as a display device), and otherwise facilitate the functionality of the user interfaces described and illustrated by way of the examples herein.

The memory can be coupled to the MCU 104 via a PCB and/or be part of the TCCs 110A-D and/or the backplane PCB 1400. The memory can be one or more non-transitory computer readable media having stored thereon instructions comprising executable code that, when executed by one or more processors (e.g., processors of the MCU 104 and/or PCBs hosting the TCCs 110A-D), causes the one or more processors to generate, provide to the display 105, and otherwise facilitate the functionality of the user interfaces described and illustrated by way of the examples herein.

Referring now to FIGS. 20A-G, an exemplary modular and adaptive user interface 2000 of the disclosed leak testing system 100 in “independent channel mode” during live test execution is illustrated. In this mode, each functional leak testing system 100 channel is represented by an individual channel section 2002A-D on the user interface 2000, which dynamically displays channel-specific test data, controls, and results. For example, the test data can be obtained by the MCU 104 (e.g., from the TCCs 110A-D and/or the backplane PCB 1400) based on tests performed by the TCCs 110A-D based on control of the pneumatic components 108A-D. Thus, the channel sections 2002A-D correspond to channels or associated TCCs 110A-D and channel boxes 106A-D, respectively.

Each of the channel sections 2002A-D displays unique elements, such as test program details, live sensor readings (including pressure and flow), and pass/fail indicators. The channel sections 2002A-D are resizable and rearrangeable based on user interaction, user role, and/or current state of the leak testing system 100 and/or channel(s). The user interface 2000 adjusts in real-time in some examples to reflect the status of each channel. For example, active channels display a “running” status along with a progress bar and detailed process steps of particular tests the TCCs 110A-D are programmed to perform. Completed tests present tabulated results that include the date, time, result status (pass or fail), and associated parameters. Idle channels, on the other hand, provide a “start” button for initiating new tests.

The functionality of the user interface 2000 is also role-based, meaning that the controls and indicators visible in each channel section 2002A-D are dictated by the user's role. Operators are provided with essential controls, such as start and abort buttons, and simplified results. Supervisors have access to expanded features, including program selection options and detailed tabulated step results. Service technicians can view diagnostic data, such as detailed sensor readings and valve states, which assist in troubleshooting issues. As shown, interactive elements include start and abort buttons for controlling tests, real-time graphical displays of metrics such as pressure and flow through process curve displays, clear visual cues for test outcomes via accept and reject indicators, and comprehensive step-by-step test outcomes for each channel through tabulated results.

Despite each channel operating independently, the user interface 2000 maintains a visually consistent structure, which enhances usability and minimizes the risk of user error. For example, the use of color-coded indicators, such as green for pass and red for abort, provides intuitive and immediate feedback. The leak testing system 100 in some examples also supports multi-channel testing, demonstrating the ability of the user interface 2000 to simultaneously execute different test programs on different channels. This capability is further highlighted when channels run distinct test types, such as gauge pressure decay and differential pressure decay, which showcases the flexibility and modularity of the leak testing system 100 architecture.

FIGS. 20A-G exemplify the adaptive and modular nature of the user interface 2000, illustrating its significance in streamlining operations, minimizing human error, and improving the overall user experience. The dynamic configurability of the user interface 2000 ensures its relevance across a wide range of testing scenarios and user roles, aligning with the advanced functionality described herein.

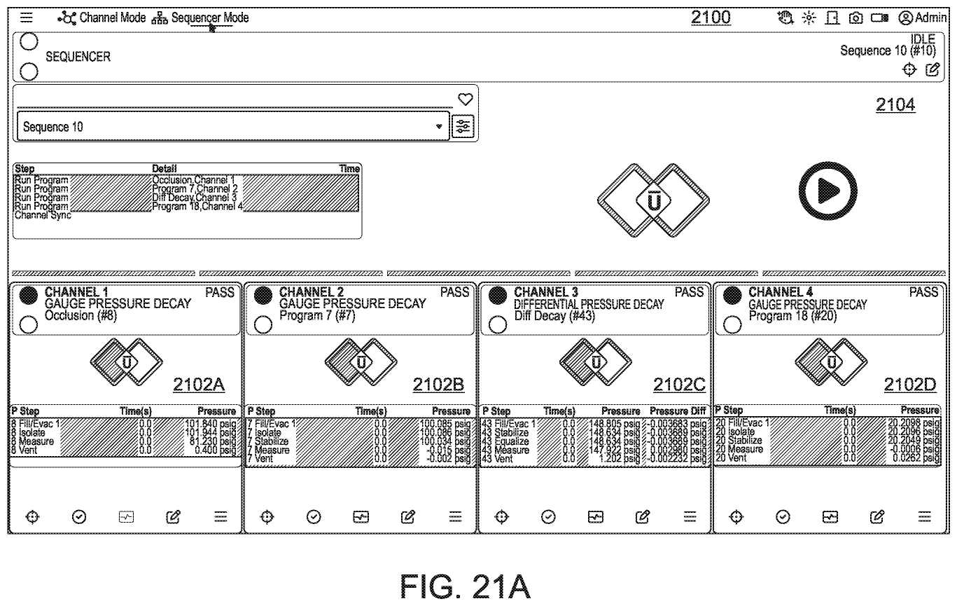

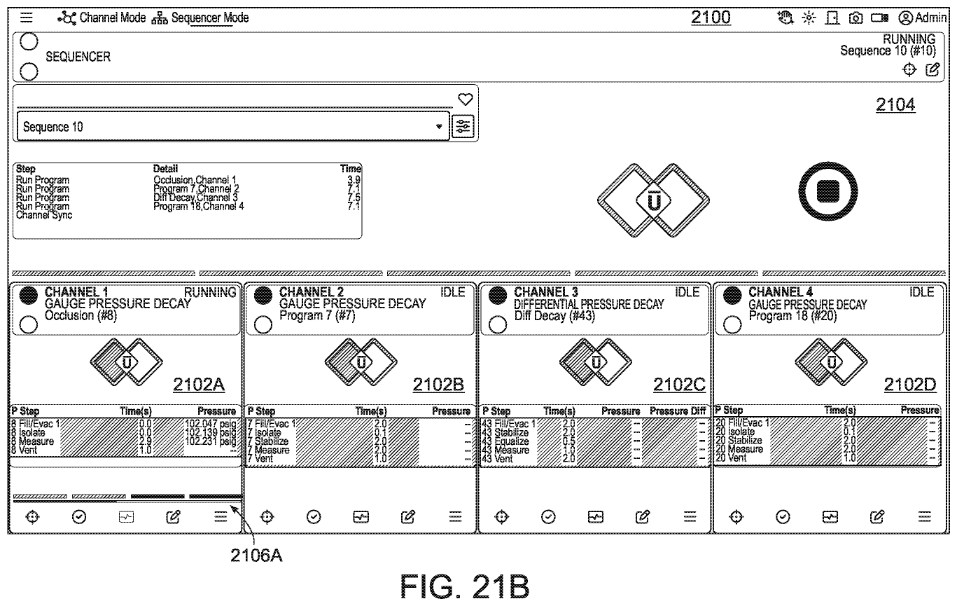

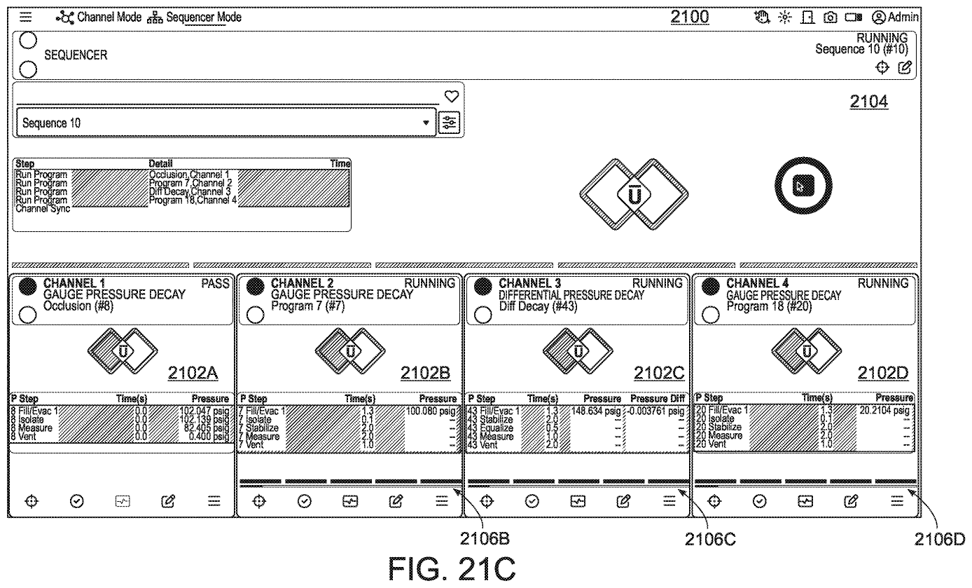

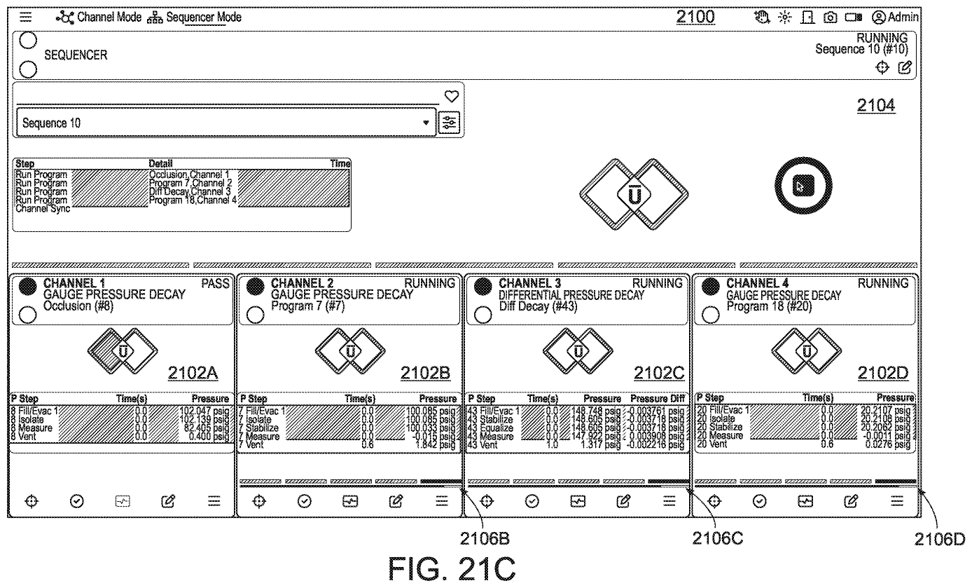

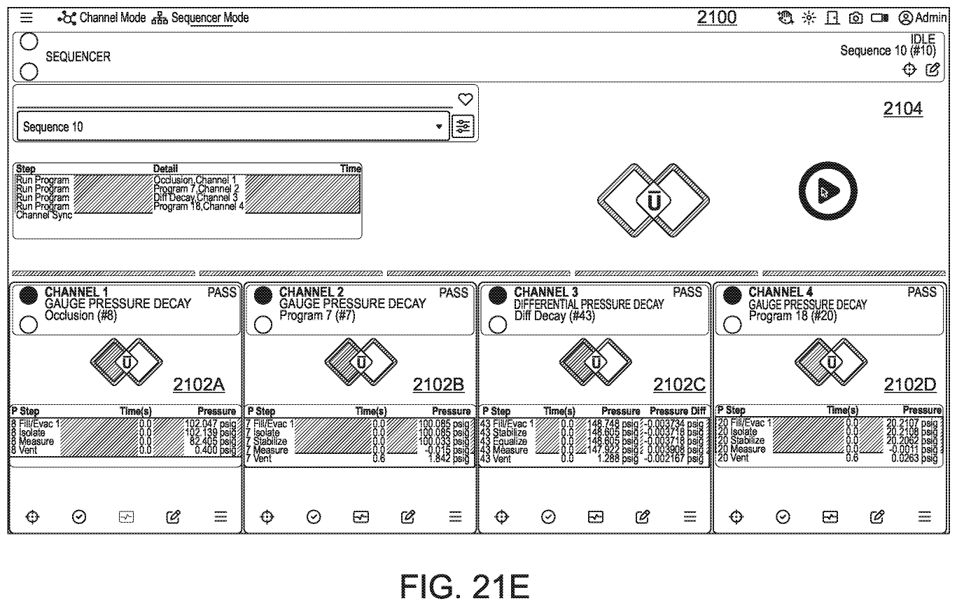

FIGS. 21A-E illustrate a sequencer mode of an exemplary customizable modular user interface 2100, which is designed to coordinate operations across multiple channels in a predefined sequence. This sequencer mode highlights the flexibility of sequencing tests, offering a visual representation of the test progress of individual channels in channel sections 2102A-D and their combined status within the context of the defined sequence in a sequence section 2104 of the user interface 2100.

FIG. 21B depicts the initial setup for the sequencer mode. The user interface 2100 shows the sequence steps listed in the upper sequence section 2104, with each step providing details such as channel assignment and the specific test program. At the bottom of the user interface 2100, individual channel sections 2102A-D present summary information, such as the selected test type (e.g., Gauge Pressure Decay) and the readiness of the channels to start the sequence. A green “start” button is prominently displayed, indicating that the sequence is ready to initiate. While four channel sections 2102A-D are illustrated, any number of channel sections can be included in any of the user interfaces described and illustrated herein in other examples.

FIGS. 21B-D illustrate the sequencer mode after initiation, where the sequence status changes to “running.” The progress bars 2106A-D at the bottom of each of the channel sections 2102A-D updates dynamically, providing real-time feedback. The channel sections 2102A-D display information such as pressure, step time, and sequence progress. Channels executing their assigned tests show a “running” status, while others await their turn. FIGS. 21B-D demonstrate the flexibility of asynchronous operation within the sequence.

FIGS. 21C-D show the sequencer mode in a mid-sequence state. At this stage, some channels have completed their assigned tests, which are marked with a “pass” status, while others remain in progress and display a “running” status. Detailed step information for the sequence continues to be visible in the upper sequence section 2104, allowing users to track the progress of each test program.

FIG. 21E illustrates the full completion of the sequence. Upon finishing, the sequencer interface indicates a “pass” status for all active channels. Test results for each channel are displayed in their respective channel sections 2102A-D. A summary of the completed sequence steps is provided, confirming the successful execution of the sequence and signaling readiness for the next sequence. At this stage, the “stop” button becomes accessible, allowing users to terminate the sequence if necessary for maintenance or adjustment.

In some embodiments, specific channels may display failure indicators, such as red icons or “fail” statuses, to highlight errors that have occurred during the sequence. The user interface 2100, for example, can dynamically adjust to bring attention to diagnostic tools and provides detailed error information, offering actionable insights for troubleshooting. Despite the error condition, the sequencer mode remains active for channels that are unaffected, which underscores the resilience and modularity of the leak testing system 100 and the user interface 2100, for example. Thus, FIGS. 21A-E showcase the capabilities of the modular user interface 2100 in sequencer mode, emphasizing its adaptability, real-time responsiveness, and user-centered design. The user interface 2100 integrates test progress monitoring, error diagnostics, and role-based customization to ensure the efficient management of complex test sequences.

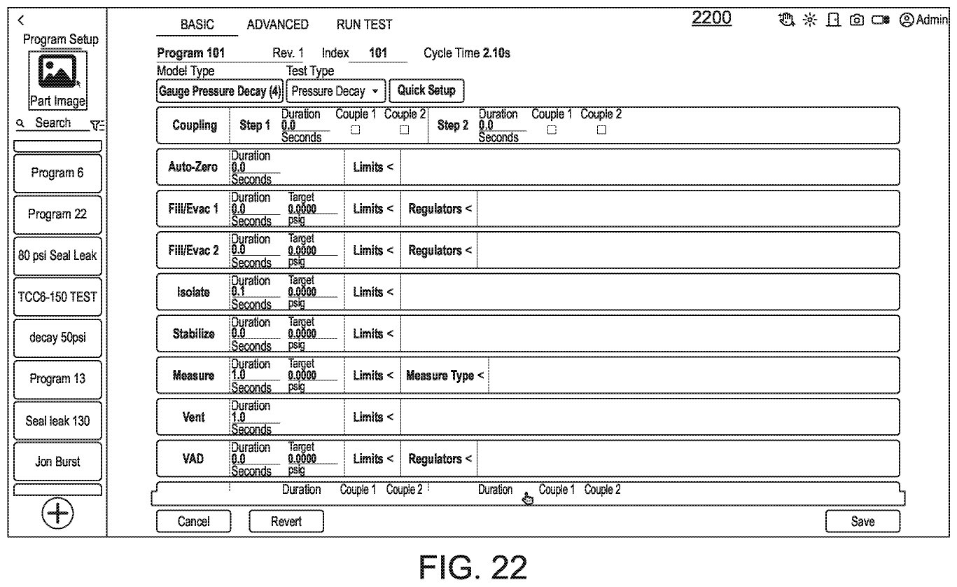

FIG. 22 illustrates an exemplary advanced program setup user interface 2200, showing a detailed step-by-step configuration for an exemplary program. The advanced program setup user interface 2200 includes specific test sequences and parameters (e.g., pressure limits, regulators, and durations), which can be customized per test requirement.

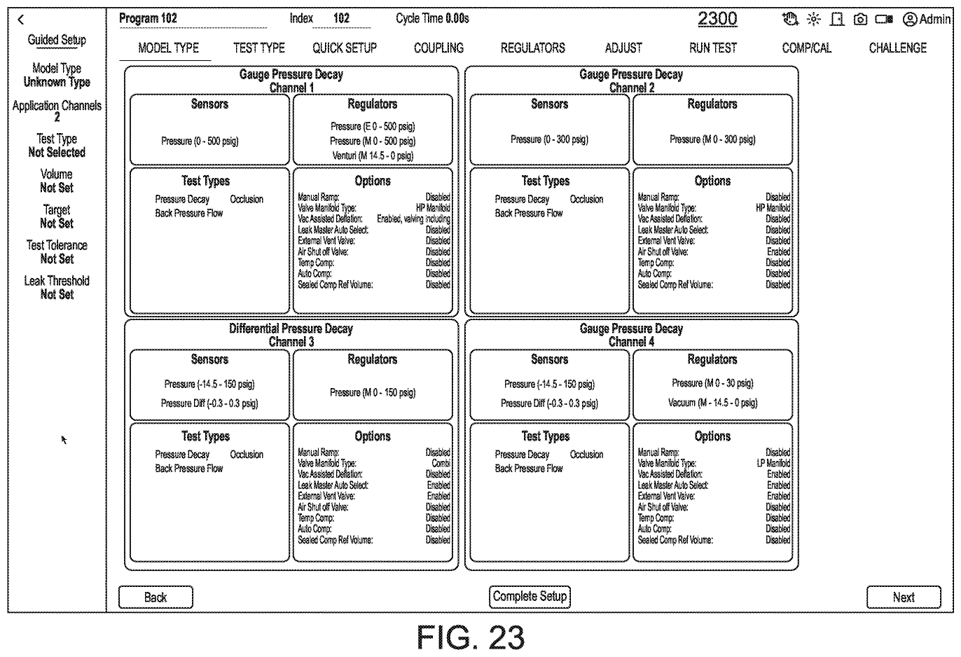

FIG. 23 illustrates an overview of an exemplary guided setup user interface 2300 for an exemplary program. The guided setup user interface 2300 displays a structured matrix, categorizing test types, sensors, regulators, and options for multiple channels. The modular guided setup interface 2300 facilitates navigation and configuration of channel-specific settings.

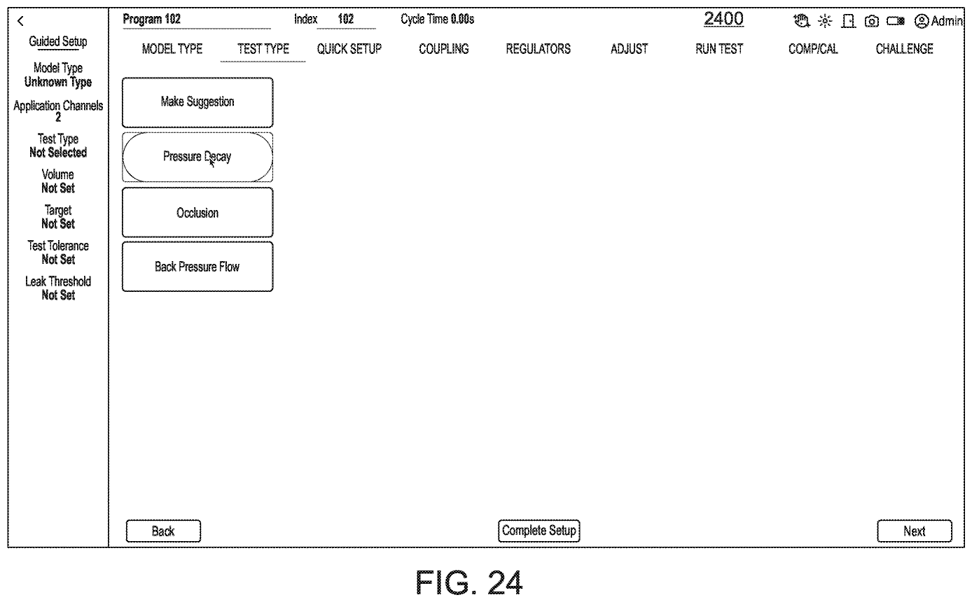

FIG. 24 illustrates an exemplary test type selection user interface 2400, offering various predefined test options, such as pressure decay, occlusion, and back pressure flow. A user can select appropriate test types based on the application requirements via the test type selection user interface 2400.

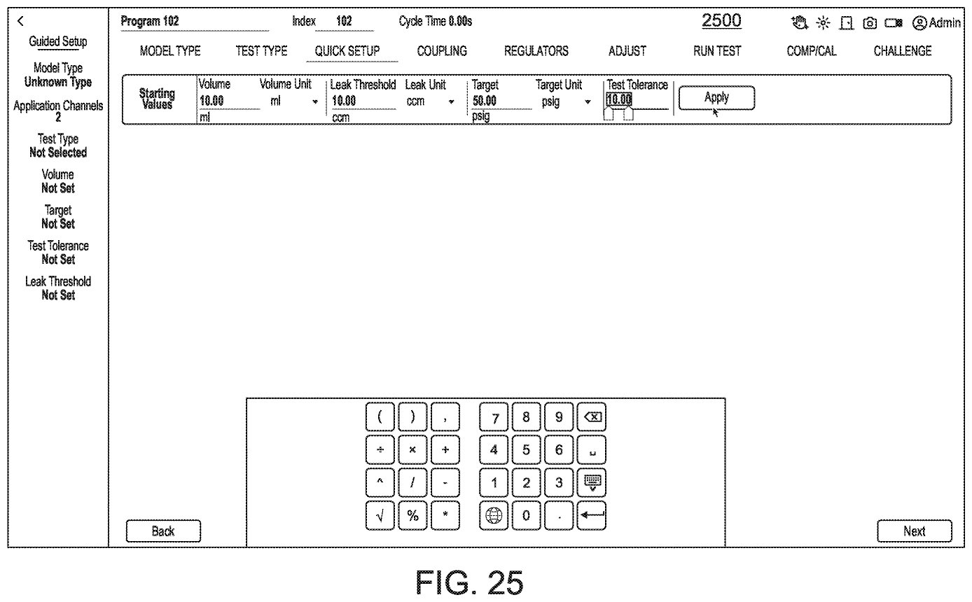

FIG. 25 illustrates an exemplary quick setup user interface 2500 for an exemplary program. The quick setup user interface 2500 displays editable starting values, test tolerances, and leak thresholds, emphasizing the ease of configuration for rapid deployment.

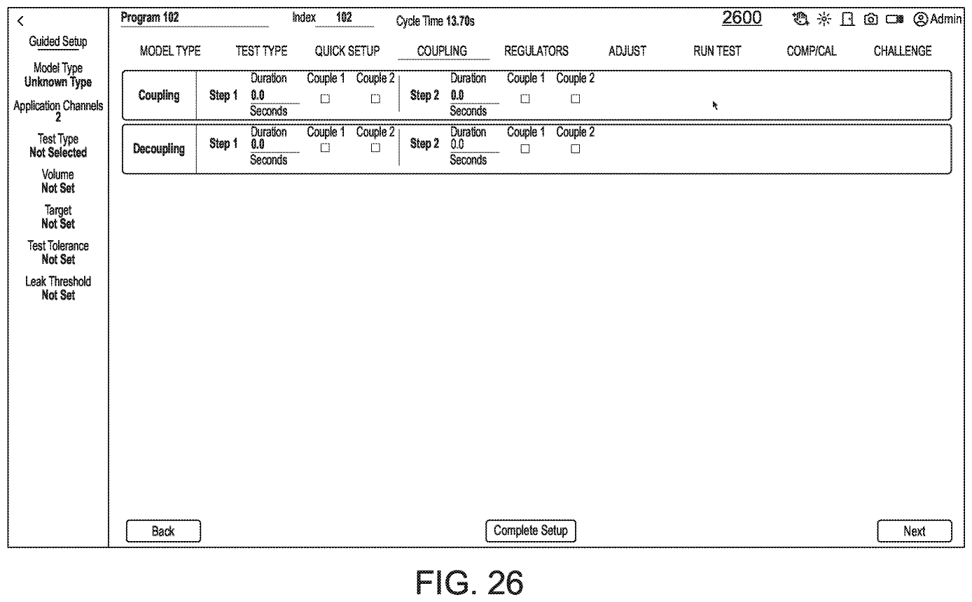

FIG. 26 illustrates an exemplary coupling configuration user interface 2600. The coupling configuration user interface allows users to graphically visualize coupling/decoupling of the channel boxes 106A-D and associated duration with each test sequence step.

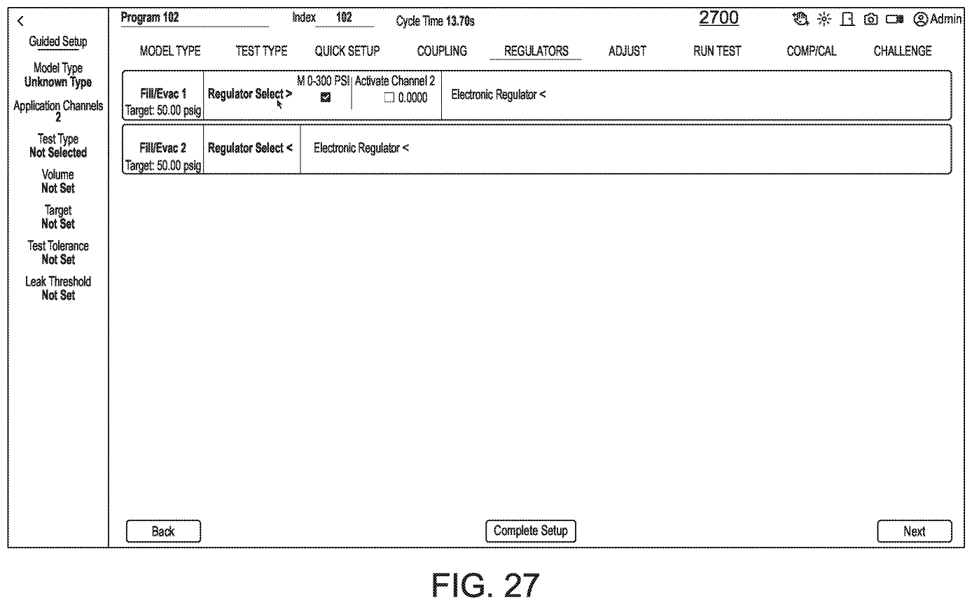

FIG. 27 illustrates an exemplary regulators configuration user interface 2700. With the regulators configuration user interface 2700, users can assign and calibrate electronic regulators for each test step. Parameters such as target pressure and allowable tolerances can be adjusted to optimize performance.

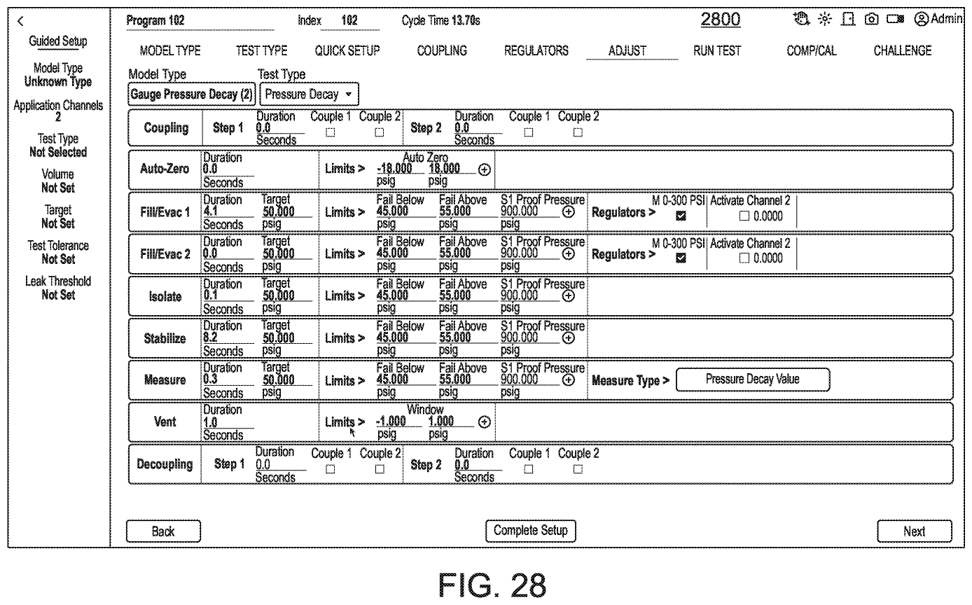

FIG. 28 illustrates an exemplary adjust user interface 2800, showing a granular breakdown of test steps. The adjust user interface 2800 includes configurable parameters like duration, pressure limits, and regulator selection for each phase, such as “fill/evac” and “measure.”

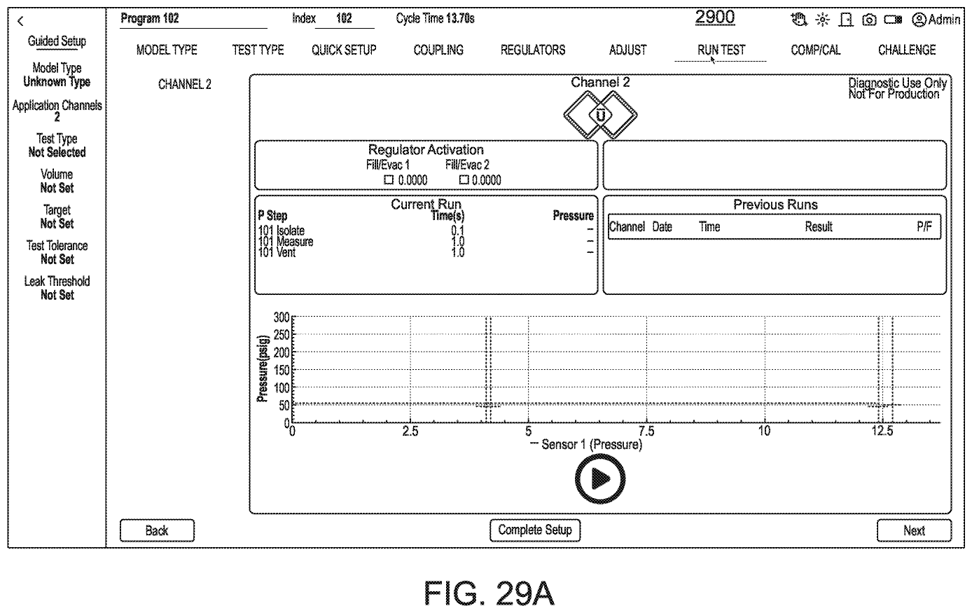

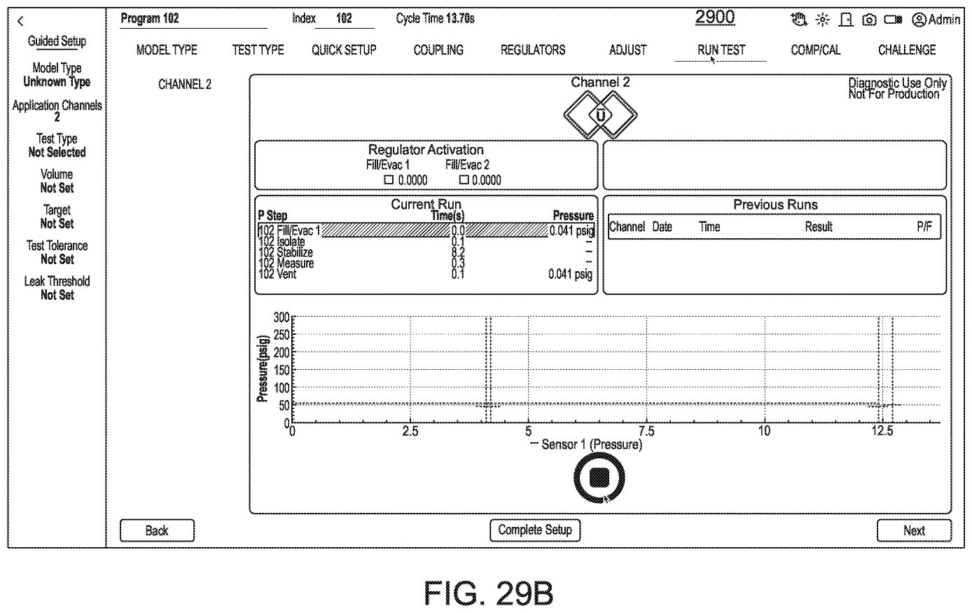

FIGS. 29A-29B illustrate an exemplary run test user interface 2900 for a test program. In some examples, the run test user interface 2900 is a sandbox for users to run and adjust test programs to refine the test programs prior to saving the program settings. The run test user interface 2900 includes real-time data visualization, such as pressure curves, and displays regulator activation status, current run details, and previous test results for monitoring.

FIG. 29B expands on FIG. 29A, illustrating the test in progress with highlighted active steps and real-time pressure data. The run test user interface 2900 in this example demonstrates diagnostic tools for analyzing test performance and troubleshooting.

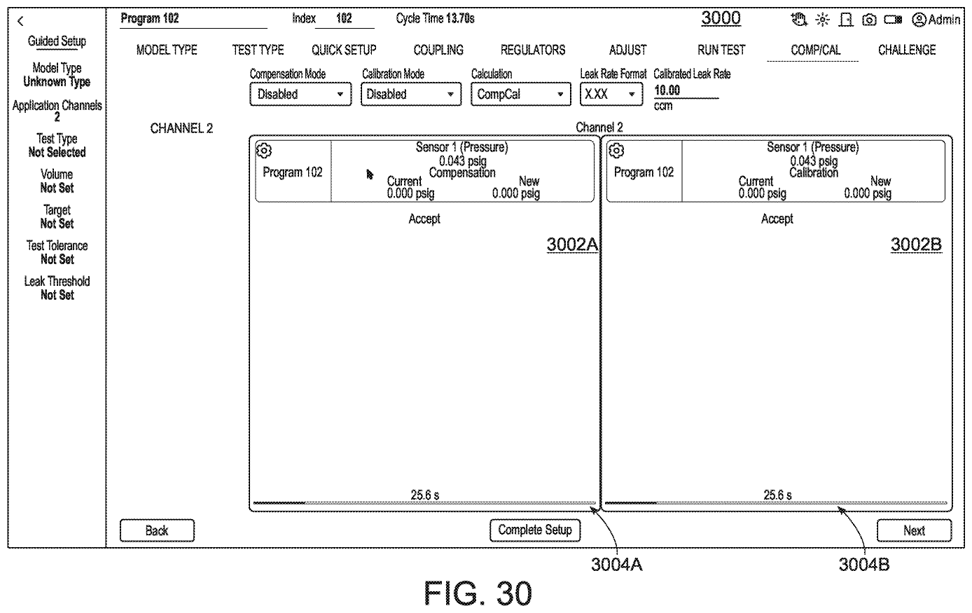

FIG. 30 illustrates an exemplary compensation/calibration user interface 3000 for a test program. The compensation/calibration user interface 3000 displays two panes for compensation/calibration: a first pane 3002A representing the compensation test with specific attributes (e.g., offset and deviation values) and another pane 3002B for the calibration test with a known leak standard. Key metrics such as the sensor output values, offset compensation, and calibration result are summarized within the panes 3002A-B. A time progress bar 3004A-B at the bottom indicates the duration of the calibration process, enabling real-time monitoring of the test.

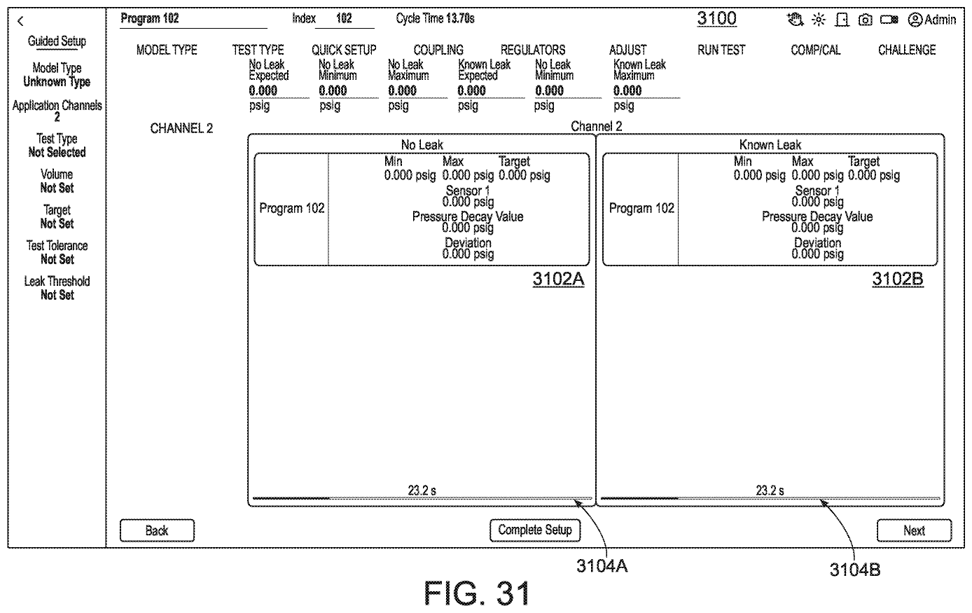

FIG. 31 illustrates an exemplary challenge test user interface 3100 for a test program. The challenge test user interface 3100 is segmented into two primary views, including a no leak view 3102A and a known leak view 3102B. Each of the views 3102A-B is defined by its respective test attributes, including pressure values, deviation tolerances, and expected outcomes. Detailed results from the current test program execution are listed in the views 3102A-B, supporting validation against known parameters. The bottom progress bar 3104 highlights the time elapsed during the challenge test, facilitating precise tracking of testing durations.

While various illustrative embodiments incorporating the principles of the present teachings have been disclosed, the present teachings are not limited to the disclosed embodiments. Instead, this application is intended to cover any variations, uses, or adaptations of the present teachings and use its general principles. Further, this application is intended to cover such departures from the present disclosure that are within known or customary practice in the art to which these teachings pertain.

In the above detailed description, reference is made to the accompanying drawings, which form a part hereof. In the drawings, similar symbols typically identify similar components, unless context dictates otherwise. The illustrative embodiments described in the present disclosure are not meant to be limiting. Other embodiments may be used, and other changes may be made, without departing from the spirit or scope of the subject matter presented herein. It will be readily understood that various features of the present disclosure, as generally described herein, and illustrated in the Figures, can be arranged, substituted, combined, separated, and designed in a wide variety of different configurations, all of which are explicitly contemplated herein.

The present disclosure is not to be limited in terms of the particular embodiments described in this application, which are intended as illustrations of various features. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. It is to be understood that this disclosure is not limited to particular methods, reagents, compounds, compositions or biological systems, which can, of course, vary. It is also to be understood that the terminology used herein is for the purpose of describing particular embodiments only and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein are generally intended as “open” terms (for example, the term “including” should be interpreted as “including but not limited to,” the term “having” should be interpreted as “having at least,” the term “includes” should be interpreted as “includes but is not limited to,” et cetera). While various compositions, methods, and devices are described in terms of “comprising” various components or steps (interpreted as meaning “including, but not limited to”), the compositions, methods, and devices can also “consist essentially of” or “consist of” the various components and steps, and such terminology should be interpreted as defining essentially closed-member groups.

As used in this document, the singular forms “a,” “an,” and “the” include plural references unless the context clearly dictates otherwise. Unless defined otherwise, all technical and scientific terms used herein have the same meaning as commonly understood by one of ordinary skill in the art. Nothing in this disclosure is to be construed as an admission that the embodiments described in this disclosure are not entitled to antedate such disclosure by virtue of prior invention.

In addition, even if a specific number is explicitly recited, those skilled in the art will recognize that such recitation should be interpreted to mean at least the recited number (for example, the bare recitation of “two recitations,” without other modifiers, means at least two recitations, or two or more recitations). Furthermore, in those instances where a convention analogous to “at least one of A, B, and C, et cetera” is used, in general such a construction is intended in the sense one having skill in the art would understand the convention (for example, “a system having at least one of A, B, and C” would include but not be limited to systems that have A alone, B alone, C alone, A and B together, A and C together, B and C together, and/or A, B, and C together, et cetera). In those instances where a convention analogous to “at least one of A, B, or C, et cetera” is used, in general such a construction is intended in the sense one having skill in the art would understand the convention (for example, “a system having at least one of A, B, or C” would include but not be limited to systems that have A alone, B alone, C alone, A and B together, A and C together, B and C together, and/or A, B, and C together, et cetera). It will be further understood by those within the art that virtually any disjunctive word and/or phrase presenting two or more alternative terms, whether in the description, sample embodiments, or drawings, should be understood to contemplate the possibilities of including one of the terms, either of the terms, or both terms. For example, the phrase “A or B” will be understood to include the possibilities of “A” or “B” or “A and B.”

In addition, where features of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, et cetera. As a non-limiting example, each range discussed herein can be readily broken down into a lower third, middle third and upper third, et cetera. As will also be understood by one skilled in the art all language such as “up to,” “at least,” and the like include the number recited and refer to ranges that can be subsequently broken down into subranges as discussed above. Finally, as will be understood by one skilled in the art, a range includes each individual member. Thus, for example, a group having 1-3 components refers to groups having 1, 2, or 3 components. Similarly, a group having 1-5 components refers to groups having 1, 2, 3, 4, or 5 components, and so forth.

Various of the above-disclosed and other features and functions, or alternatives thereof, may be combined into many other different systems or applications. Various presently unforeseen or unanticipated alternatives, modifications, variations or improvements therein may be subsequently made by those skilled in the art, each of which is also intended to be encompassed by the disclosed embodiments.

Having thus described the basic concept of the invention, it will be rather apparent to those skilled in the art that the foregoing detailed disclosure is intended to be presented by way of example only and is not limiting. Various alterations, improvements, and modifications will occur and are intended to those skilled in the art, though not expressly stated herein. These alterations, improvements, and modifications are intended to be suggested hereby, and are within the spirit and scope of the invention. Additionally, the recited order of processing elements or sequences, or the use of numbers, letters, or other designations, therefore, is not intended to limit the claimed processes to any order except as may be specified in the claims. Accordingly, the invention is limited only by the following claims and equivalents thereto.

What is claimed is:

1. A leak testing system, comprising:
a plurality of channel boxes each comprising a test channel controller (TCC) and a plurality of pneumatic components, wherein each of the TCCs is configured to perform a different test procedure using the pneumatic components; and
an enclosure coupled to a display device and housing memory having instructions stored thereon and a main control unit (MCU), wherein the enclosure is configured to separately receive each of the channel boxes and thereby pneumatically couple the channel boxes to the enclosure, wherein the MCU is coupled to the memory, communicably coupled to the TCCs when the channel boxes are received by the enclosure, and configured to execute the stored instructions to:
obtain from each of the TCCs test data for the different test procedures;
generate a user interface graphically representing the test data and comprising a plurality of channel sections each corresponding to a respective channel comprising one of the channel boxes and an associated with one of the TCCs; and
output the user interface to the display device for display.

2. The leak testing system of claim 1, wherein each of the channel boxes is separately removable from the enclosure via detachment of a receiving manifold of the channel box from a distribution manifold of the enclosure.

3. The leak testing system of claim 1, wherein each of the TCCs comprises a TCC printed circuit board (PCB) comprising a first set of one or more processors, the MCU comprises a second set of one or more processors, and the enclosure further comprises a backplane printed circuit board (PCB) configured to connect the MCU to the TCC PCBs via a backplane interface connector of the TCC PCBs.

4. The leak testing system of claim 1, wherein the enclosure further comprises a set of test ports for each of the channel boxes and each of the TCCs is assigned a different sensor range or is programmed to perform a different test type or model type.

5. The leak testing system of claim 1, wherein the pneumatic components comprise at least one main regulator, at least one auxiliary manual regulator, and an internal vacuum generation circuit.

6. The leak testing system of claim 1, wherein the MCU is configured to execute the stored instructions to generate the user interface to include or exclude functionality based on stored access privileges for a user of the leak testing system after determining a role of the user after receiving a login request from the user, wherein the role comprises a system administrator, a supervisor, an operator, an information technology administrator, or a service technician.

7. The leak testing system of claim 1, wherein the user interface comprises an indication of a test pass or fail status and a start/abort button configured to control initiation and termination of one or more of the different test procedures via communication with one or more of the TCCs.

8. The leak testing system of claim 1, wherein the user interface comprises a multi-functional gauge comprising real-time sensor readings obtained from one or more of the TCCs and one or more of the pneumatic components, wherein the sensor readings comprise pressure, flow, or leak rate.

9. The leak testing system of claim 1, wherein the user interface comprises an indication of a state of one or more external digital input and output signals and a holding register display comprising real-time numerical data used in one or more of the different test procedures.

10. The leak testing system of claim 1, wherein the MCU is further configured to execute the stored instructions to continuously communicate with the TCCs to obtain updated test data and update the output user interface in real-time based on the updated test data.

11. The leak testing system of claim 1, wherein the user interface comprises a sequence section representing a progress of each of the different test procedures, wherein one or more of the different test procedures are executed concurrently by one or more of the TCCs.

12. The leak testing system of claim 1, wherein each of the channel sections comprises a progress bar indicating a completion status of a corresponding one of the different test procedures based on additional test data obtained from each of the TCCs.

13. The leak testing system of claim 1, wherein one or more of the channel boxes comprise different pressure or sensor ranges, a different number of ports, or a different number of regulators.

14. The leak testing system of claim 1, wherein the channel box comprises one or more sensors, one or more test ports, one or more pressure regulators, valving, or a TCC-to-backplane interface connector.

15. The leak testing system of claim 1, wherein each of the channel sections comprises a respective portion of the test data associated with a corresponding one of the channels.

16. A non-transitory computer readable medium having stored thereon instructions comprising executable code that, when executed by one or more processors of a leak testing system, causes the one or more processors to:
obtain test data from a plurality of test channel controllers (TCCs), wherein each of the TCCs is associated with one of a plurality of channel boxes, each of the channel boxes further comprises a plurality of pneumatic components, and each of the TCCs is configured to perform a different test procedure using the pneumatic components;
generate a user interface graphically representing the test data and comprising a plurality of channel sections each corresponding to a respective channel comprising one of the channel boxes and an associated with one of the TCCs; and
output the user interface to a display device of the leak testing system for display, wherein each of the channel sections comprises a respective portion of the test data associated with a corresponding one of the channels.

17. The non-transitory computer readable medium of claim 16, wherein the one or more processors are configured to execute the stored instructions to generate the user interface to include or exclude functionality based on stored access privileges for a user of the leak testing system after determining a role of the user after receiving a login request from the user.

18. The non-transitory computer readable medium of claim 16, wherein the user interface comprises an indication of a test pass or fail status and a start/abort button configured to control initiation and termination of one or more of the different test procedures via communication with one or more of the TCCs.

19. The non-transitory computer readable medium of claim 16, wherein each of the channel sections comprises a progress bar indicating a completion status of a corresponding one of the different test procedures based on additional test data obtained from each of the TCCs.

20. A method implemented by a leak testing system and comprising:
obtaining test data from a plurality of test channel controllers (TCCs), wherein each of the TCCs is associated with one of a plurality of channel boxes, each of the channel boxes further comprises a plurality of pneumatic components, and each of the TCCs is configured to perform a different test procedure using the pneumatic components;
generating a user interface graphically representing the test data and comprising a plurality of channel sections each corresponding to a respective channel comprising one of the channel boxes and an associated with one of the TCCs; and
outputting the user interface to a display device of the leak testing system for display, wherein each of the channel sections comprises a respective portion of the test data associated with a corresponding one of the channels.
